(19) United States
(12) Patent Application Publication
(10) Pub. No.: US 2026/0320681 A1
(43) Pub. Date: Oct. 15, 2026

(54) ELECTRONIC INFRASTRUCTURE FOR DYNAMIC WHEEL-TYPE DIGITAL INTERFACE

(71) Applicant: Gapodox LLC, San Juan, PR (US)

(72) Inventors: Roberto ZAYAS, San Juan, PR (US); Daniel REYNOLDS, Washington, MI (US); Niraj KUMAR, Guaynabo, PR (US)

(21) Appl. No.: 19/660,121

(22) Filed: Apr. 27, 2026

Related U.S. Application Data
(63) Continuation of application No. 18/737,715, filed on Jun. 7, 2024.
Application No. 18/737,715 is a continuation-in-part of application No. 18/370,852, filed on Sep. 20, 2023.
Application No. 18/370,852 is a continuation-in-part of application No. 17/948,156, filed on Sep. 19, 2022.
(60) Provisional application No. 63/295,668, filed on Dec. 31, 2021.
(60) Provisional application No. 63/408,425, filed on Sep. 20, 2022.

(51) Int. Cl. G06Q 40/04; G06Q 30/0207; G06Q 40/06

(52) U.S. Cl. CPC G06Q 40/04; G06Q 30/0216; G06Q 40/06; G06Q 40/063

(57) ABSTRACT

A method for generating a dynamic interface to display real-time information about a plurality of tradeable assets within a portfolio. The method includes receiving real-time data for each of the plurality of tradeable assets and generating a node for each tradeable asset. The nodes include a first characteristic indicative of a volume relative to the portfolio and a second characteristic indicative of a trading momentum. The method includes generating the dynamic interface which includes positioning each node within a circular common area, with the position between a center of the circular common area and an outer edge of the circular common area, the position based on the first characteristic of each node. One or more nodes has an angular movement based on the second characteristic, and the dynamic interface updates with real-time changes in the data of any of the plurality of tradeable assets.

### PRIORITY CLAIM AND RELATED APPLICATIONS

This disclosure is a continuation-in-part application of U.S. application Ser. No. 18/370,852, filed Sep. 20, 2023, which claims the benefit of provisional U.S. Application No. 63/408,425, entitled “Real-Time Equity Monitoring System, Process and Interface,” filed Sep. 20, 2022, and which is a continuation-in-part application of co-pending U.S. application Ser. No. 17/948,156 entitled “Real-Time Equity Monitoring System, Process and Interface,” filed Sep. 19, 2022, which claims the benefit of provisional U.S. Application No. 63/295,668 entitled “Real-Time Equity Monitoring System, Process and Interface,” filed Dec. 31, 2021, the technical disclosures of which are all hereby incorporated by reference in their entireties.

### BACKGROUND

### 1. Field of the Invention

This application relates generally to methods and apparatus for controlling operation of a computer display to display efficiently information and, more specifically, to user-configurable methods using an apparatus for concurrently and graphically displaying a diverse data set within a common region of a computer display.

### 2. Description of Related Art

Conventional control systems for displaying information such as financial information indicative of an equity's performance often divide the information into different sets. For example, charts can be created to display a trend of the equity's price over a defined period of time. Some systems will overlay a plurality of line graphs representing historical price trends for different equities over the defined period of time on the same chart. Viewers of such a chart can readily compare the historical performance of those different equities over the period of time represented.

However, aside from selecting the equities to be represented on the chart, and possibly the period of time encompassed by the chart, users are left with little flexibility to include additional, different information to be presented on a conventional chart for their analysis. Instead, users are required to access separately different information by navigating to a different portion of a network-accessible application. For example, users are typically required to navigate away from the displayed chart to a table of historical dividend information to view information about an equity's dividend history. Other information about the equity would also require navigating to a different interface of a network-accessible application to be viewed. In each instance, the various information viewable from the different interfaces of the network-accessible application must be remembered by the user, or written down for consideration while viewing other information. Navigating between different interfaces of a network-accessible application is not only time consuming and inefficient, but also prevents users from contemporaneously considering multiple different data sets.

More recently, bespoke applications have been developed to include interfaces that can present different data within a common interface. Bespoke solutions allow a plurality of equities to be selected for inclusion within the interface, but they are prohibitively expensive for most private users. Further, modifying bespoke solutions to vary the types of data to be included within a common interface requires amending the application at the program code level, involving dedicated software developers for such an undertaking.

### SUMMARY

Accordingly, there is a need in the art for a system, apparatus, platform and method of allowing users to configure an application to include a plurality of different categories of information, about a plurality of different tradeable assets in a common user interface. Configuration of the application can involve receiving user input specifying the categories of information from a menu included in a graphical user interface, optionally without modification of the application at a program code level.

According to one aspect, the subject application involves a method for generating a dynamic interface with a computing system to display real-time information about a plurality of tradeable assets within a portfolio. The method can include receiving data for each of the plurality of tradeable assets, wherein the data is received in real-time. The method can further include generating a node for each tradeable asset of the plurality of tradeable assets based on the data of each tradeable asset. Each node includes a first characteristic indicative of a volume relative to the plurality of tradeable assets within the portfolio and a second characteristic indicative of a trading momentum.

The method can further include generating the dynamic interface to display the real-time information about the plurality of tradeable assets. The dynamic interface may include the node for each tradeable asset located within a circular common area of the dynamic interface. Each node has a position between a center of the circular common area and an outer edge of the circular common area, the position based on the first characteristic of each node. One or more nodes has an angular movement based on the second characteristic, and the dynamic interface updates with real-time changes in the data of any of the plurality of tradeable assets.

In another aspect, the subject application involves a non-transitory computer readable medium. The non-transitory computer readable medium stores instructions that when executed by one or more processors cause the one or more processors to receive data for each of a plurality of tradeable assets, wherein the data is received in real-time.

The instructions further cause the one or more processors to generate a node for each tradeable asset of the plurality of tradeable assets based on the data of each tradeable asset. Each node includes a first characteristic indicative of a volume relative to the plurality of tradeable assets within the portfolio and a second characteristic indicative of a trading momentum. The instructions further cause the one or more processors to generate a dynamic interface to display the real-time information about the plurality of tradeable assets. The dynamic interface may include the node for each tradeable asset located within a circular common area of the dynamic interface. Each node has a position between a center of the circular common area and an outer edge of the circular common area, the position based on the first characteristic of each node. One or more nodes has an angular movement within the circular common area, the angular movement based on the second characteristic, and the dynamic interface updates with real-time changes in the data of any of the plurality of tradeable assets.

The above summary presents a simplified summary in order to provide a basic understanding of some aspects of the systems and/or methods discussed herein. This summary is not an extensive overview of the systems and/or methods discussed herein. It is not intended to identify key/critical elements or to delineate the scope of such systems and/or methods. Its sole purpose is to present some concepts in a simplified form as a prelude to the more detailed description that is presented in the pages that follow.

### BRIEF DESCRIPTIONS OF THE DRAWINGS

The invention may take physical form in certain parts and arrangement of parts, embodiments of which will be described in detail in this specification and illustrated in the accompanying drawings which form a part hereof and wherein:

FIG. 1 shows an illustrative embodiment of a computer-based system for controlling operation of a display to generate an interface including different categories of content, for a plurality of different tradeable assets within a common region of the interface.

FIG. 2 is a flow diagram schematically illustrating an illustrative embodiment of a computer-implemented process for controlling operation of a display to generate a graphical user interface that concurrently presents different categories of content, for a plurality of different tradable assets.

FIG. 3 shows an illustrative embodiment of a category content menu allowing user configuration of the categories of content to be represented in a graphical user interface.

FIG. 4 shows an illustrative embodiment of a tradeable asset menu allowing user configuration of the tradeable assets to be represented in a graphical user interface.

FIG. 5 shows an illustrative embodiment of an interface that includes a common region that concurrently displays graphical representations of numeric data and transaction data relating to a plurality of tradeable assets.

FIG. 6 is another flow diagram schematically illustrating an illustrative embodiment of a computer-implemented process for controlling operation of a display to generate a graphical user interface that concurrently presents different categories of content, for a plurality of different tradable assets.

FIG. 7A shows an illustrative embodiment of a dynamic interface of a plurality of nodes representing tradeable assets.

FIG. 7B shows another illustrative embodiment of a dynamic interface of a plurality of nodes representing tradeable assets.

FIG. 8A shows an illustrative embodiment of a connection indicator between tradeable assets.

FIG. 8B shows an illustrative embodiment of industries and sectors regarding the connection indicator.

FIG. 9 shows an illustrative embodiment of a dynamic interface of a plurality of wedges representing tradeable asset classes.

FIGS. 10A-10B illustrate screenshots setting forth exemplary leaderboards of ranked users/traders.

FIG. 11 illustrates a screenshot of an exemplary “wheel” interface that concurrently displays graphical representations of numeric data and transaction data relating to a portfolio of tradeable assets.

FIG. 12 illustrates a screenshot displaying information to a user when the “Data” button of the screen shown in FIG. 11 is selected.

FIGS. 13A-13C illustrate a screenshot displaying exemplary alerts displayed to a user regarding the tradeable assets in his portfolio or tradeable assets the user elects to follow.

FIG. 14 illustrates a screenshot of another embodiment of a dynamic wheel interface, where this wheel interface provides a dynamic visual representation tracking a plurality of tradeable assets.

FIG. 15 illustrates a screenshot displaying information to a user when the “Data” button of the screen shown in FIG. 14 is selected.

FIGS. 16A-16C illustrate a screenshot displaying exemplary alerts to a user regarding the tradeable assets displayed in the interface of FIG. 15 when the “Alerts” button is selected.

FIG. 17 illustrates a screenshot of another embodiment of a dynamic wheel interface, where this wheel interface provides a dynamic visual representation tracking a plurality of assets comprising stock options.

FIG. 18 illustrates a screenshot displaying information regarding the option assets displayed on the wheel interface of FIG. 17 when the “Data” button is selected.

FIGS. 19A-19C illustrate a screenshot displaying exemplary alerts to a user regarding the option assets displayed in the interface of FIG. 17 when the “Alerts” button is selected.

FIG. 20 illustrates a screenshot of another embodiment of a dynamic wheel interface, where this wheel interface provides a dynamic visual representation tracking a plurality of cryptocurrencies.

FIG. 21 illustrates a screenshot displaying information to a user when the “Data” button pf the screen shown in FIG. 20 is selected.

FIGS. 22A-22B illustrate a screenshot displaying exemplary alerts to a user regarding the cryptocurrency assets displayed in the interface of FIG. 20 when the “Alerts” button is selected.

FIG. 23 illustrates a screenshot of a list of certain portfolios that are known through the platform.

FIG. 24 illustrates a screenshot of a different list of portfolios that are accessible through the platform.

FIG. 25 illustrates a screenshot of a list of portfolios that are being “followed” by a user of the platform.

FIG. 26 illustrates a screenshot of another embodiment of a dynamic wheel interface, where this wheel interface provides a dynamic visual representation tracking a plurality of tradeable assets commonly held in portfolios being “followed” by the viewing user.

FIG. 27 illustrates a screenshot displaying information regarding the commonly held assets displayed on the wheel interface of FIG. 26 when the “Data” button is selected.

FIGS. 28A-28B illustrates a screenshot displaying exemplary alerts to a user regarding the option assets displayed in the interface of FIG. 26 when the “Alerts” button is selected. and

FIG. 29 illustrates an embodiment of a computing system configured with the systems and/or processes disclosed herein.

### DETAILED DESCRIPTION

Certain terminology is used herein for convenience only and is not to be taken as a limitation on the present invention. Relative language used herein is best understood with reference to the drawings, in which like numerals are used to identify like or similar items. Further, in the drawings, certain features may be shown in somewhat schematic form.

It is also to be noted that the phrase “at least one of”, if used herein, followed by a plurality of members herein means one of the members, or a combination of more than one of the members. For example, the phrase “at least one of a first widget and a second widget” means in the present application: the first widget, the second widget, or the first widget and the second widget. Likewise, “at least one of a first widget, a second widget and a third widget” means in the present application: the first widget, the second widget, the third widget, the first widget and the second widget, the first widget and the third widget, the second widget and the third widget, or the first widget and the second widget and the third widget.

There is a need in the art for apparatus and methods for controlling operation of a computer display to generate an interface including different categories of content, for a plurality of different tradeable assets within a common region of the interface. The migration of equities trading to electronic exchanges accessible over a communication network such as the Internet, for example, has made real-time information readily available to traders conducting research on equities and other tradeable assets. Traders have traditionally been required to collect different types of information for individual equities from different interfaces, such as a summary page, a table of historical dividend payments, a compilation of insider transactions, etc. Each different category of information would then be separately considered by traders to make a decision regarding whether to buy, sell or hold each individual equity.

The above process is time consuming for traders with large portfolios because individual equities were researched separately. Further, the above process is substantially the same process performed by traders in the pre-Internet era, although using more up-to-date information. Rather than compiling different categories of information about equities from printed publications, real-time data is retrieved electronically from a database. The end result is that traders separately considered different categories of information about equities, individually, and then moved on to research the next equity of interest.

In contrast, the present technology controls operation of a computer display to generate an interface comprising a common region that concurrently displays content within a plurality of different categories, for a plurality of different tradeable assets such as equities. Such equities and tradeable assets include any category of information for which dynamic data may be garnered and displayed to a user in the manner disclosed herein. For example such assets or equities may be financial in nature, such as corporate stocks or commodities like oil, gas, natural gas, and other energy industries, or may be non-financial or entertainment in nature, such as sports statistics and related data. The technology is user configurable, which allows the user to select or otherwise specify, without modification at a program code level of an executable application: (i) the different tradeable assets, and (ii) the different categories of content to be concurrently displayed in the common region of the interface for each of the different tradeable assets. Data falling within each of the different categories can be retrieved for each of the selected equities over a communication network such as the Internet, for example, and concurrently and graphically represented within the common region of the interface. Upon viewing the common region of the interface, a trader can readily glean for each equity, based on graphical elements within the common region, one, a plurality, or all of:
(i) whether one or more particular events has occurred and/or will occur,
(ii) a timing of any events that have occurred and/or will occur,
(iii) a quantity of events that have occurred,
(iv) whether the equity offers an occasional distribution, and
(v) and a recommendation whether to conduct a transaction involving the equity.

Unlike traditional technologies, the present technology allows traders to configure a portfolio of tradeable assets and all categories of content desired by the traders to be concurrently displayed using graphical elements within a common region of an interface. As a result, significantly more information can be aggregated from remote terminals, and displayed within the region of the interface than if the underlying data was displayed in a purely alpha-numeric format. Because much of the underlying data changes in real time based on activity occurring on the electronic exchanges as sales, option grants/exercises, dividend payments, etc. occur, the present technology allows for consideration of large amounts of data in a timely fashion, before conditions change. The display controlled as described herein can therefore present a larger quantity of information than it otherwise could by displaying the underlying data. Further, the concurrently-displayed graphical elements convey trends in the underlying data that may not be immediately visible from a purely alpha-numeric display. Traders are able to evaluate all categories of content graphically represented within the common region of the interface, for a full portfolio of tradeable assets. Such an evaluation can occur without requiring traders to navigate to various different interfaces and separately evaluate different categories of content, for an individual tradeable asset, greatly improving the efficiency of the interface. The portfolio configuration can optionally be saved by traders in a user account, to be opened and updated without requiring a trader to reconfigure the portfolio.

### Exemplary System

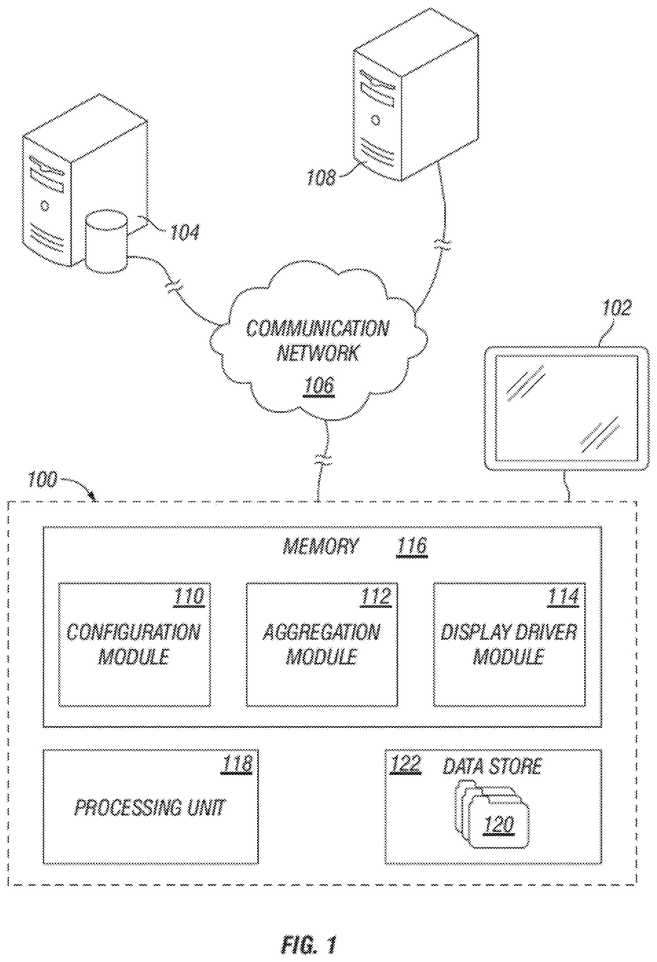

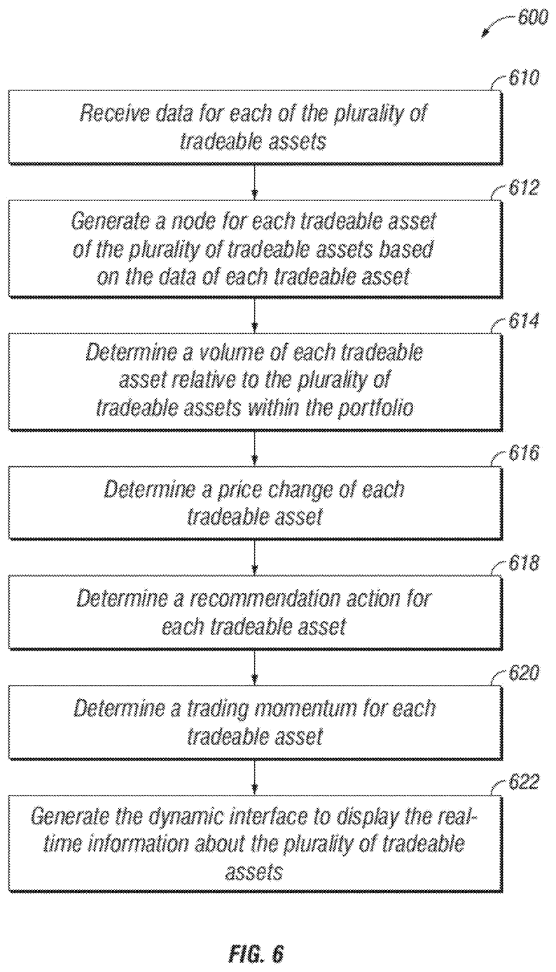

With reference to the drawings, FIG. 1 shows an illustrative embodiment of a computing system 100 for controlling operation of a computer display 102 to display a graphical user interface, as described below. The graphical user interface includes different categories of content, for a plurality of different tradeable assets, graphically represented within a common region of the interface. In one embodiment, the computing system 100 is implemented as a computing device 600 described in detail below with respect to FIG. 6. According to another embodiment, the computing system 100 is a computing/data processing system including an application or collection of distributed applications for enterprise organizations. The applications and computing system 100 may be configured to operate with, or be implemented as a cloud-based networking system, a software as a service (SaaS) architecture, a node in a cluster computing system or another type of network architecture.

In one embodiment, the computing system 100 is a centralized server-side application that performs at least the computerized functions disclosed herein and that electronically communicates with a plurality of nodes such as a database server 104, for example, over a communications network 106 such as the Internet. The computing system 100 and one or more remote terminals such as the database server 104 can optionally operate together to store and process data as described herein.

The present disclosure describes embodiments of the computing system 100 as a client-side application locally connected to the computer display 102 for the sake of brevity and clarity. However, alternate embodiments of the computing system 100 can be deployed as a server-side, hosted application that performs the functions described herein, for concurrent connections with a plurality of network-connected terminals. For example, web server 108 can be configured with a hosted application accessible by remote terminals such as the computing system 100 over the communication network 106. The web server 108 can access the database server 104 to retrieve data included in different categories of content as described herein, and to serve content over the communication network 106 to the computing system 100 to be displayed by the computer display 102.

One or more of the components of the computing system 100 can be embodied as program modules (e.g., configuration module 110, aggregation module 112, display driver module 114) stored in a memory 116 of the computing system 100. The program modules are configured with instructions that, when executed by circuitry of at least a processing unit 118, cause the computing system 100 to perform the corresponding function(s).

As described in greater detail with reference to FIG. 6, the processing unit 118 can be, for example, one or more hardware processors, such as, a microprocessor, central processing unit (CPU), application-specific integrated circuit (ASIC), or similar hardware device, or array thereof. The processing unit 118 is connected via circuitry (e.g., a bus) to the memory 116 and to the data store 122 via one or more input/output controllers. The memory 116 is, for example, a non-transitory memory such as a cache memory of a processor, a flash memory, a random-access memory (RAM), cache memory or other active memory that stores instructions executed by the processing unit 118.

One or more data structures 120 storing data of a user account associated with a trader can be stored in the data store 122. The data store 122 can be, for example, a flash memory, hard-disk drive or similar volatile or non-volatile computer-storage media. Accordingly, the processing unit 118 uses the data store 122 and/or the memory 116 to store various data when performing the functions described herein. As shown in FIG. 1, the data store 122 is integrated with the computing system 100. Of course, in other embodiments, the data store 122 can be implemented as a distributed storage that is shared among one or more remote devices such as the database server 104 and the web server 108, and the computing system 100 in a distributed file system.

As used herein, the communication network 108 comprises a computer network hardware, software applications, public communication transmission components such as public telephone switching networks and the like to facilitate packetized or other communications between the computing system 100 and remote devices as described herein. For example, the communication network 108 can comprise a local area network (“LAN”), a wide area network (“WAN”), the Internet, or a combination thereof.

### Exemplary Process for Generating an Interface

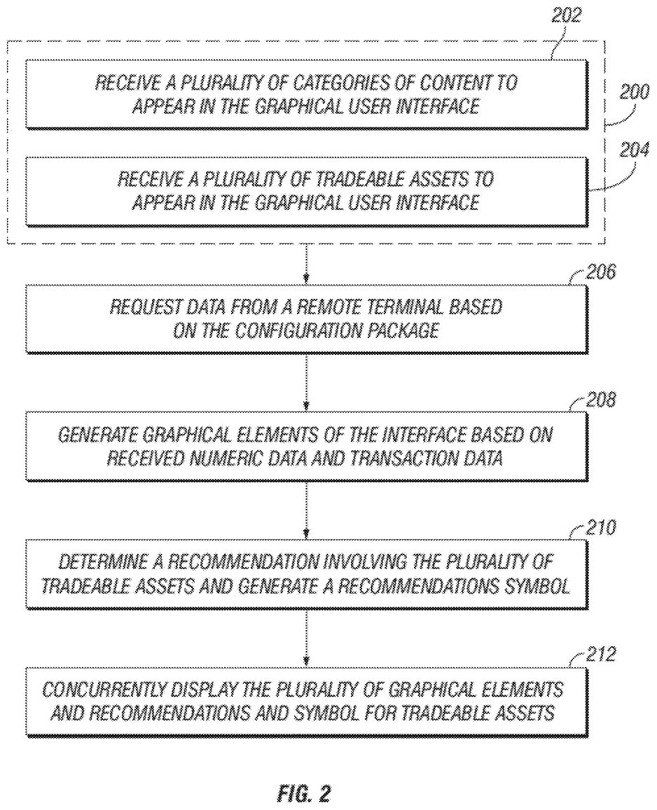

An illustrative embodiment of a computer-implemented process of controlling operation of the computer display 102 to generate a graphical user interface is shown in FIG. 2. The graphical user interface concurrently and graphically presents content in a plurality of different categories, for a plurality of different tradeable securities, within a common display region of the interface.

At block 200 in FIG. 2, the configuration module of the computing system receives a configuration package that defines the categories of content, and the tradeable assets that are to be concurrently displayed within the common region of the interface. For example, as part of the configuration package, the configuration module receives user-defined categories of content at block 202, and a plurality of tradeable assets at block 204. The categories of content are described herein as being user-configurable, or user-defined, meaning a user of the present technology can individually select, or otherwise specify the categories the user desires to appear in the interface.

At block 206, the aggregation module communicates with the remote server over the communication network to request and retrieve data within the categories of content, and for each of the tradeable assets specified in the configuration package. The data requests at least numeric data and transaction data corresponding to the tradeable assets. According to some embodiments, the numeric data for each selected tradeable asset includes, but are not limited to:
sales prices of the tradeable assets involved in transactions (e.g., sales) that occurred within a defined historical period of time preceding the date on which the data is requested,
the current market price of the tradeable asset at the time the data is requested, and
option strike prices for the tradeable asset at the time the data is requested.

Examples of the transaction data for each tradeable asset selected include, but are not limited to:

Historical trades (e.g., purchases, sales and option grants) involving insiders affiliated with the corporation related to the tradeable asset, or have access to information related to the tradeable security that is not publicly available. As specific examples, the information about historical trades requested can include at least one of, for each of the tradeable assets selected, a name and title of the insiders who have traded the tradeable asset, dates on which the insiders have traded the tradeable asset, a volume of the tradeable asset traded by the insiders, and whether the insider has engaged in at least one of: (i) a purchase of the tradeable asset, (ii) a sale of the tradable asset, (iii) an exercise of an option issued for the tradeable asset, and (iv) a receipt of a grant of the tradeable asset, and
upcoming dividend payments scheduled to be paid to holders of the tradeable security within a defined period of time from the date on which the data is requested.

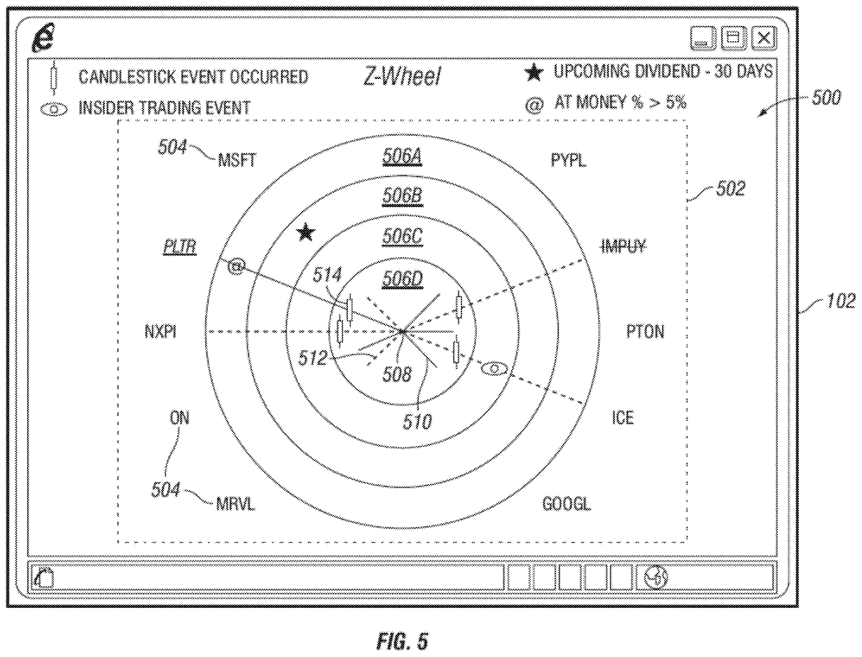

At block 208 in FIG. 2, the display driver module generates graphical elements of an interface, an illustrative embodiment of which is shown in FIG. 5, based on the numeric data and the transaction data received by the aggregation module. For example, the interface 500 can include a common region 502 (enclosed by broken lines) in which each of the graphical elements is concurrently displayed, to convey graphically information related to the numeric data and the transaction data received by the aggregation module.

Referring again to FIG. 2, based on the totality of factors specified in the configuration package, the display driver module determines, at block 210, a recommendation involving each of the plurality of tradeable assets represented in the common region (see FIG. 5) of the interface.

At block 212 in FIG. 2, the display driver module controls transmission of a signal to the display, to cause the display to present the interface to the user. Based on the information graphically conveyed by the interface, the user can initiate a recommended transaction involving one or more of the tradeable assets. The interface includes the common region in which, for each of the tradeable assets in the configuration package, an activity symbol is arranged within a central region of the common region, the dividend symbol overlays a portion of the activity symbol, and the recommendation symbol is arranged about a perimeter region of the activity symbol. According to alternate embodiments, the display driver module can transmit a signal that automatically triggers a transaction involving the tradeable asset, without human intervention, based on the recommendations determined by the display driver module.

### Exemplary Menus

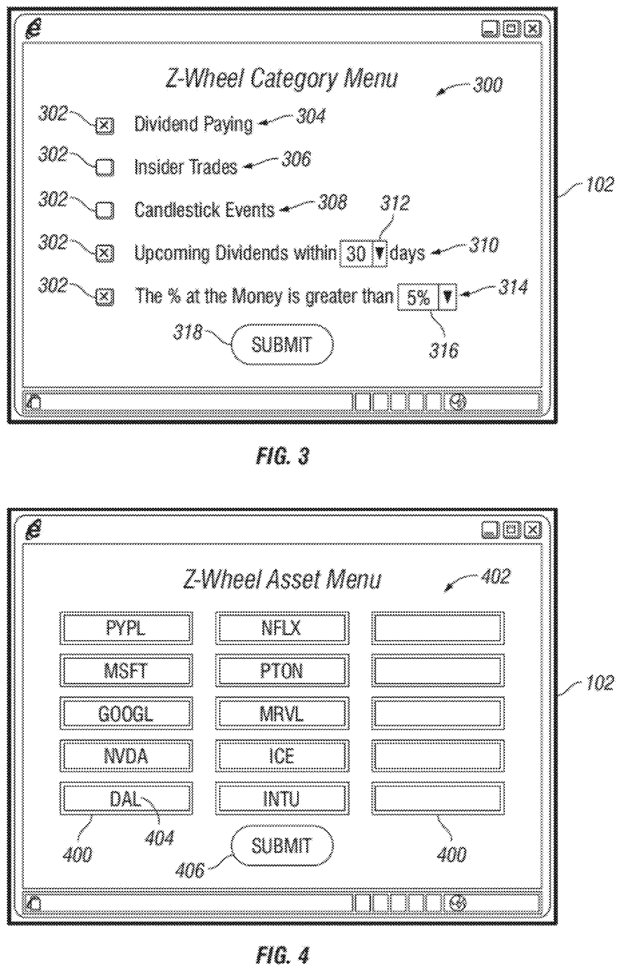

Turning to FIG. 3, by way of example, a defined list of available categories can be displayed in a menu 300 by the computer display as shown in the embodiment of FIG. 3. The user can select check boxes 302 for a plurality (but fewer than all available options), or all available options of categories available from the menu 300. According to alternate embodiments, any suitable selection mechanism other than check boxes 302, such as radio buttons, pull-down menus, text entry fields, etc. can be used in place of, or in addition to the check boxes 302 shown in FIG. 3.

For the embodiment shown in FIG. 3, the menu 300 includes the following available categories of content to be included in the interface:
dividend paying tradeable assets 304—designation of those tradeable assets selected for inclusion that issue occasional, and optionally regular distributions of currency.
insider trades involving the tradeable asset 306—indications of whether trades have occurred within a defined time frame, involving the tradeable asset by any party that has access to information material to the price of the tradeable asset that is not available to the general public.

Candlestick events 308—a price chart format that can be used for technical analysis includes a graphic that concurrently displays high, low, open, and closing prices for a specific period for a given financial instrument is referred to as a “candlestick” chart. Designed similar to the candlestick marker (discussed below in further detail and shown in FIG. 5), the candlestick includes an upper tail and lower tail that represent the high and low prices, respectively, achieved for the instrument during a time period, typically a trading session such as a day for example. The body segment is rectangular in shape, and represents the opening and closing for a trading period, and can be color coded to represent whether the instrument closed at a higher or lower price than it opened. Patterns can be both simple and complex, and optionally user-definable through the selection of desired criteria via interfaces within the menu 300. For example, the user can establish candlestick criteria that includes at least one of a threshold: opening price, closing price, high price, and low price during a trading session. Satisfaction of at least one, a plurality (but less than all), or all of the candlestick criteria during a trading session constitutes a candlestick event. Although the foregoing example describes a candlestick pattern as defining high, low, close and open prices, it is understood that other patterns indicative of market manipulation can constitute “candlestick” patterns, as used herein. For example, criteria can be user-defined in the menu 300 to be satisfied according to so-called EG Wyckoff distribution patterns can be used to determine when/if “candlestick” events have occurred. Wyckoff patterns are helpful to determine when large-volume investors build short positions or distribute long positions and surpass the activity of retail traders. The large-volume investors distribute positions gradually to avoid the price from changing significantly before they can complete their distributions. For the sake of brevity and clarity, however, embodiments utilizing the high, low, close open criteria of candlestick events are described herein.
upcoming dividend or other distribution 310 scheduled to be paid within a defined period of time 312 defined by the user from a date on which the data is to be requested; and
a percentage of at the money 314 exceeds a defined percentage 316 specified by the user—a percentage of the tradeable asset that is at a market price within the defined percentage 316 (or other tolerance) of an option strike price for a defined percentage of outstanding options to purchase the tradeable asset. However, other embodiments of the technology can include a subset of the options in the menu 300, or additional options not shown in the embodiment of the menu 300 in FIG. 3. Upon selecting the desired categories of content, the selection can be submitted for inclusion in the configuration package in response to selection of the confirmation button 318.

In addition to the desired categories of content, the user can also define the plurality of tradeable assets to be included in the interface. For the illustrative embodiment shown in FIG. 4, ticker symbol entry fields 400 can be included in a tradeable asset selector 402. Stock ticker symbols representing equities of specific corporations can be entered in each field for inclusion in the configuration package defining the tradeable assets represented in the interface. In FIG. 4, the ticker symbol DAL 404 is typed into one of the ticker symbol entry fields 400. In response to selection of the confirm button 406, the equities of Delta Airlines and other tradeable assets will be incorporated into the configuration package, to be included in the interface. According to alternate embodiments, the name, or a portion of the name of the corporation can be entered into the ticker symbol entry fields 400, and a lookup will be performed in the background. According to some embodiments, at least ten (10), and up to fifty (50) tradeable assets can be submitted in the configuration package for inclusion in the interface.

The configuration package includes the user-definable settings for generation of the interface as described herein, and is stored by the configuration module in a data structure in the data store. The data structure can also associate the configuration package with a user account of the user, allowing the user to save the configuration package for future evaluations of the user's portfolio. By specifying the categories of content and the tradeable assets that are to appear in the interface, the user is able to configure the computing system to display the desired content without modifying the source/program code of the configuration module.

### Exemplary Wheel Interface

Referring to FIG. 5, an interface 500 that includes a common region 502 that concurrently displays graphical representations of numeric data and transaction data relating to a plurality of tradeable assets is shown. According to the embodiment shown in FIG. 5, the plurality of ticker symbols 504 defined by the configuration package are arranged about a periphery of a plurality of concentrically-aligned, annular regions 506A, 506B, 506C, 506D. Information pertaining to each ticker symbol 504 is designated by placement of one or more graphical elements in the annular regions 506A, 506B, 506C, 506D, extending in a radial direction from an origin 508 towards the respective ticker symbol 504. Placement of the ticker symbols 504 may be indicative of the volume of the tradeable assets corresponding to the ticker symbols. In one embodiment, the placement of the ticker symbols 504 is indicative on increasing volume, with volume increasing in a clockwise direction. For example, PYPL would have the smallest volume relative to the portfolio and MSFT would have the largest volume relative to the portfolio. In another embodiment, the placement of the ticker symbols 504 is indicative on increasing volume, with volume increasing in a counterclockwise direction. For example, MSFT would have the smallest volume relative to the portfolio and PYPL would have the largest volume relative to the portfolio.

The interface 500 may further include a line extending from the origin 508 toward each ticker symbol 504. The lines can be dividend symbols that include at least: (i) a first variable aspect, and (ii) a second variable aspect. An example of the first variable aspect can be an appearance of the line that graphically indicates whether a dividend is paid to holders of the tradeable asset. In FIG. 5, for example, a solid line 510 having a relatively-light line weight indicates that the tradeable asset with the corresponding ticker symbol, GOOGL in this example, does not pay a dividend. In contrast, a broken line 512 having a relatively-heavy line weight indicates that the tradeable asset with the corresponding ticker symbol, MRVL in this example, does pay a dividend. However, other graphical aspects of the line such as a color code, a size, a shape, or any other graphical element can be utilized as the first variable aspect. For example, a first color line (e.g., grey) may graphically indicate that the tradeable asset and a second color line (e.g., green) may indicate that the tradeable asset pays a dividend.

The second variable aspect of the lines can graphically indicate a relative quantity of events that occurred, or are scheduled to occur involving the tradeable asset. According to the illustrative embodiment in FIG. 5, the longer the line, the greater the number of events that have occurred, or are scheduled to occur involving the tradeable asset. As a specific example, a number of events that have occurred involving the tradeable asset ICE is greater than a number of events that have occurred involving the tradeable asset PTON. However, other graphical aspects of the line such as a color code, a size, a shape, or any other graphical element can be utilized as the first variable aspect. According to some embodiments, examples of the events include, but are not limited to: candlestick events, insider trades, impending dividend events, any other event, and any combination thereof. Thus, for the embodiment shown in FIG. 5, the first variable aspect (e.g., solid, low-weight line v. broken, heavy-weight line) indicates whether the respective tradeable asset pays a dividend, and the second variable aspect (length of line) indicates a number of events that have occurred, or will occur.

In addition to the lines, additional symbols can be arranged within the annular regions 506A, 506B, 506C, 506D, in the radial direction extending from the origin 508 to the respective ticker symbol 504. For example, a marker such as the “at” symbol (@) can be placed in annular region 506A, which can be designated for markers that identify tradeable assets for which the “at the money” percentage exceeds the user-configurable percentage specified in the configuration package. The “at the money” percentage is a percentage of the outstanding options for a tradeable asset that, at the current market price, is within a defined tolerance of the option strike price. In the illustrative embodiment of FIG. 5, the defined tolerance was specified as five (5%) in the configuration package.

Similarly, annular region 506B can be designated to display markers such as a star (★), which is indicative of an upcoming dividend payment within a user-defined period from the date on which the numeric and transaction data is received by the aggregation module 112. In the example of FIG. 5, the star (★) indicates the tradeable asset MSFT has an upcoming dividend payment within the next thirty (30) days.

Annular region 506C can be designated to display markers such as an eye, which indicates an insider trading event has occurred. Insider trades involve a transaction involving the respective tradeable asset by a party who has information that is not available to the general public. Whether an insider trading event has occurred is determined by the display driver module based on transaction data received by the aggregation module.

Annular region 506C can be designated to display markers such as candlestick marker 514 in FIG. 5. The candlestick marker 514 includes a vertical, rectangular section that indicates the open and close prices of the tradeable asset, an upward projecting line that identifies the high price achieved by the tradeable asset during a trading session, and a downward projecting line that identifies the low price achieved by the tradeable asset during the trading session. The configuration package can optionally be configurable by the user to specify the high, low, open close prices to be satisfied for designation of a tradeable asset with the candlestick marker 514.

The common region 502 may comprise additional annular regions. For example, an annular region may be designated to display markers indicative of a strong or weak lunar phase performance for a tradeable asset, which may be based on the received data. If an asset performs better around a new moon phase, an indication will be presented notifying the user that the tradeable asset will be entering a historically better performing period. Alternatively, a different indication may be presented notifying the user that the tradeable asset will be entering a historically weaker performing period if in the full moon phase. Thus, it is advantageous to provide the user with indications of lunar cycle performance that enables the user to capitalize on the forthcoming performance.

The common region 502 may also comprise a natural ratio region. The natural ratio region may be based on the correlation of the trading movement of a tradeable asset and the Fibonacci sequence. The natural ratio is obtained by diving successive pairs of Fibonacci numbers, yielding approximately 1.618 (or conversely 0.618). The natural region may utilize Fibonacci retracements, Fibonacci arcs, Fibonacci fans, Fibonacci zones, or any combination thereof to determine the natural ratio for a tradeable asset. The determination may also utilize other methods known in the art. For example, an annular region may be designated to display markers indicative of a strong or weak performance for a tradeable asset correlated to the natural ratio based on the received data. If an asset is projected as performing better in the future, an indication will be presented notifying the user that the tradeable asset will be entering a historically better performing period. Alternatively, a different indication may be presented notifying the user that the tradeable asset will be entering a historically weaker performing period if projected to lose value.

The common region 502 may also comprise a crowded short selling region. The crowded short selling region may be based on data indicating a large amount of short selling positions for a tradeable asset, indicating increased risk in purchasing a short position on the tradeable asset. If an asset is demonstrating a crowded short sell tendency, an indication will be presented notifying the user that the tradeable asset will be entering a risky performing period. The common region 502 may also comprise a call option region and/or a put option region. The option regions provide a user with information indicating whether other investors are predicting a strong or weak performance on the tradeable asset. An indication will be presented notifying the user that the tradeable asset will be entering a projected better performing period based on the option positions. Accordingly, it is advantageous to provide annular regions and corresponding indications in this manner because the user can make decisions with all pertinent information on one screen. Thus, the user can promptly execute trades, maximizing the value of the trade. Without having information presented in this manner, a user would not be able to execute prompt trades and fail to maximize the position.

### Artificial Intelligence

In each of the above-described embodiments for the tradeable assets, artificial intelligence (AI) may be employed to manage the user's investments based performance. The AI may suggest trading recommendations based on, for example, the user's trading tendencies. For example, the AI may provide buy or sell recommendations for the user's tradeable assets based on the user's historical actions for candlestick events, insider trading events, upcoming dividends (or no dividends), at the money, and/or natural ratio occurrence. The AI may provide buy or sell recommendations for the user's tradeable assets based on the user's historical actions with the same asset or similar assets. Additionally, the AI may ask the user questions about the portfolio to optimize the holdings. For example, the AI may learn that the user has a preference for assets within a certain class or sector (e.g., energy, finance, healthcare, telecommunications, etc.) and provides recommendations for assets within that class or sector. Further, the AI may learn that the user has a preference for characteristics (e.g., pays dividends, short selling, etc.) of these assets and provides recommendations for assets within that class or sector that match the user's preferred characteristics.

According to some embodiments, the recommendation for the tradeable assets can be to purchase a quantity of the tradeable asset, to sell a quantity of the tradeable asset, or to hold the tradeable asset. A recommendation symbol such as a unique typeface for the ticker symbols 504, or other distinguishing feature or icon for the ticker symbols 504 to graphically convey the recommendation to the user. By way of example, the display driver module recommends selling the tradeable asset IMPUY by formatting the ticker symbol 504 bold, with strikethrough. As another example, the recommendation determined by the display deriver module is to hold the tradeable asset with ticker symbol PLTR, as indicated by the italicized, underlined text. The remaining tradeable assets have received “buy” recommendations, as indicated by standard block lettering. A “buy” recommendation informs the user that the conditions specified in the configuration package have been satisfied, justifying the purchase of quantities of the corresponding tradable asset. However, any other distinguishing feature such as color, letter case, stylized font, any other symbol, etc. can be used to convey graphically the recommendation to the user. The interface 500 may further be configured to incorporate alerts and/or sounds to notify a user of a trade recommendation. The user may receive a blinking or static red indication to sell a tradeable asset. The user may receive a blinking green indication to buy a tradeable asset. The user may receive a blinking or static red indication to sell a tradeable asset. The user may receive a blinking or static yellow indication to hold a tradeable asset. The color and presentation (e.g., blinking) may vary. Additionally, the user may receive notifications (e.g., email, mobile application, text messaging) concerning trade recommendations.

### Socialization

The interface 500 may further be configured for socialization among users such as to present shared top performing portfolios of other traders and/or the portfolio of traders the user is following. In at least one embodiment of socialization, the interface 500 may be configured to display the common holdings of every portfolio the user is following. A common holding may be any predetermined number (e.g., 1 or more) set by the user. For example, by setting the common holding threshold at 2, the interface 500 would present every tradeable asset that at least two other traders are currently holding. An advantage of this type of socialization presentation is that the user is able to determine common assets that are held by other traders and assess the assets on a single screen, thereby increasing the efficiency of the decision-making process. For example, users following the top performers can view their shared portfolios and related metrics, including the number of stocks in the portfolio, the average return for the portfolio, and total portfolio value.

Additionally, with such socialization the user may have access to the shared portfolios of other users, observing details such as which assets they are buying, selling, and/or holding, and the volumes. The interface 500 may further be configured to enable the user to select an adjustment feature to mimic a top performing portfolio. For example, if the user selects the adjustment feature, the user will trade into the same positions as the other portfolio, based on (for example) proportionality of available assets.

### Exemplary Process for Generating a Real-Time Interface

With reference to FIG. 6, a flow diagram of a process 600 for generating a dynamic interface with a computing system to display real-time information about a plurality of tradeable assets within a portfolio is illustrated. The process 600 includes receiving 610 data for each of the plurality of tradeable assets. The data may be received from multiple databases and aggregated. A node is generated 612 for each tradeable asset based on the data. A determination 614, 616, 618, 620 of a volume, price change, recommendation action, and trading momentum is made for each tradeable asset. The dynamic interface is generated 622 to display the real-time information about the plurality of tradeable assets.

### Exemplary Dynamic Interfaces

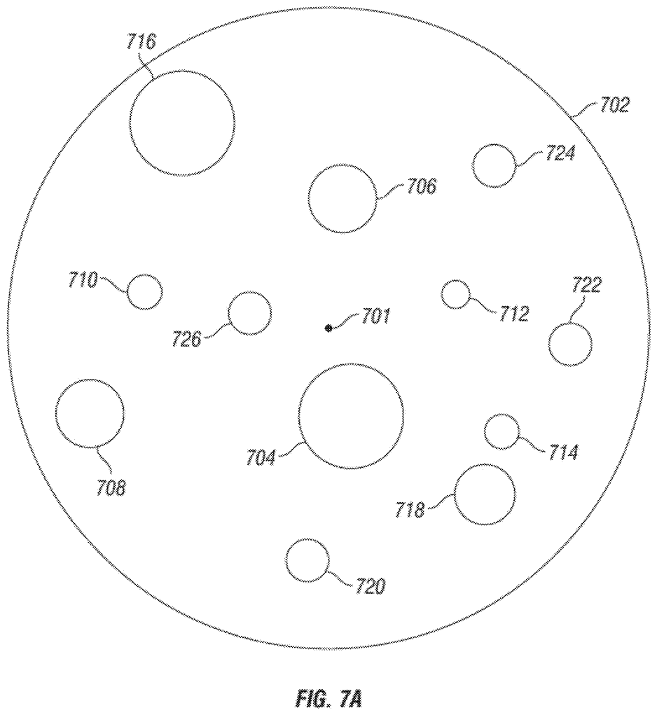

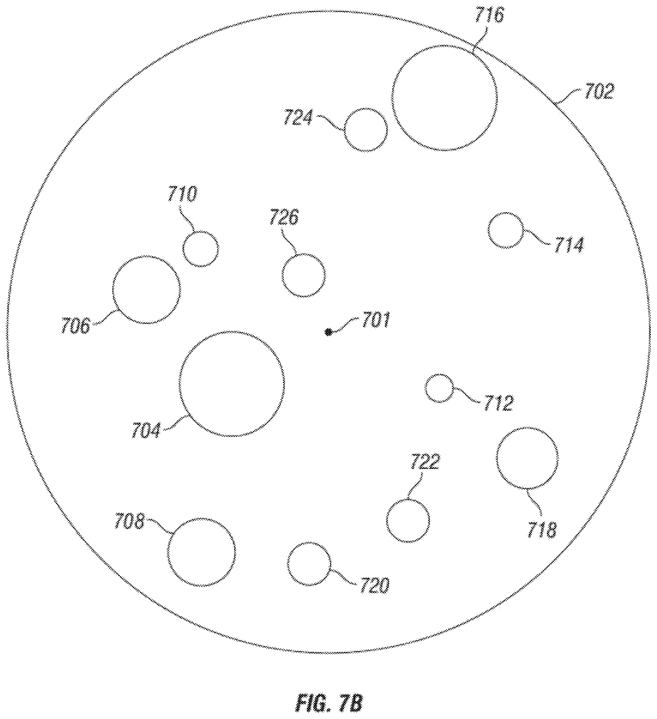

Referring to FIG. 7A and FIG. 7B, dynamic interfaces of a plurality of nodes representing tradeable assets are illustrated at two different time period. The dynamic interface includes a circular common area 702 where the plurality of nodes are positioned. As described herein, the plurality of nodes includes characteristics based on the data of the tradeable assets.

### Exemplary Characteristics

A first characteristic may be indicative of a volume owned by the user relative to the plurality of tradeable assets within the portfolio. The tradeable assets are positioned between a center 701 of the circular common area and an outer edge of the circular common area, with the position based on the first characteristic. In one embodiment, tradeable assets having a larger volume may be positioned towards the center 701 and tradeable assets having a smaller volume may be positioned towards the outer edge. Additionally, the circular common area 702 may be segmented into bands corresponding to various ranges of volume. For example, node 704 would have a larger volume relative to the portfolio because it is positioned towards the center 701. In contrast, node 722 would have a smaller volume relative to the portfolio because it is positioned towards the outer edge of the circular common area. In another embodiment, tradeable assets having a larger volume may be positioned towards the outer edge and tradeable assets having a smaller volume may be positioned towards center 701 of the circular common area. For example, node 716 would have a larger volume relative to the portfolio because it is positioned towards the outer edge. In contrast, node 722 would have a smaller volume relative to the portfolio because it is positioned towards the center 701 of the circular common area.

A second characteristic may be indicative of a trading momentum of a tradeable asset. The nodes of the tradeable asset have an angular movement based within the circular common area, with the direction indicating how the asset is trading (e.g., asset is increasing or decreasing in value). Tradeable assets having a positive trading momentum have a clockwise angular movement, with the speed of the angular movement increasing with a larger positive trading momentum value. Tradeable assets having a negative trading momentum have a counterclockwise angular movement, with the speed of the angular movement increasing with a larger negative trading momentum value. The speed of the trading momentum can be based on a 10-day trend. The 10-day trend may be defined as the change (if any) between the previous closing session price and the closing price 10 days prior. Alternatively, the trend may be based on a different number of days. The speed of the trading momentum can be segmented into groups (e.g., quartiles) corresponding to the degree of change in the trend. For example, a trading momentum in the first quartile may correspond to a change between (±) 0%-2% and correlates to the node having a first rotation speed (e.g., very slow rotation). A trading momentum in the second quartile may correspond to a change between (±) 3%-6% and correlates to the node having a second rotation speed (e.g., slow rotation). A trading momentum in the third quartile may correspond to a change between (±) 7%-10% and correlates to the node having a third rotation speed (e.g., medium rotation). A trading momentum in the fourth quartile may correspond to a change between (±) 10% and correlates to the node having a fourth rotation speed (e.g., fast rotation).

For example, nodes 704, 710, 712, 716, 726, and 722 have a positive trading momentum with a clockwise angular movement, indicating that the value of the asset is increasing. Further, node 722 has a large positive trading momentum because its position has drastically changed during the time period, indicating that the value of the asset is rapidly increasing. In contrast, node 710 has a small positive trading momentum because its position has minimally changed during the time period, indicating that the value of the asset is slowly increasing. The trading momentum may be based on percentage of new buyers/sellers of the tradeable assets and/or the volume of the tradeable asset that is being purchased or sold. The trading momentum may additionally or alternatively be based on the rate of change in the market price of the tradeable asset.

Nodes 706, 708, 714, 718, and 724 have a negative trading momentum with a counterclockwise angular movement, indicating that the value of the asset is decreasing. Node 714 has large negative trading momentum because its position has drastically changed during the time period, indicating that the value of the asset is rapidly decreasing. In contrast, node 718 has a small negative trading momentum because its position has minimally changed during the time period, indicating that the value of the asset is slowly decreasing. Node 720 does not have a trading momentum because it is in the same position, indicating that the value of the asset has not changed. It is advantageous to provide a user with the above information in this manner because the user can assess their entire portfolio in a single window. For example, the user can assess whether a heavily held asset is rapidly losing value that they should decrease their position. Alternatively, the user can assess whether a nominally held asset is rapidly gaining value that they should increase their position.

With continued reference to FIGS. 7A and 7B, a third characteristic is indicative of a price change is the size of the node, with increasing size correlated to increasing value and decreasing size correlated to decreasing value. The third characteristic may be based on the market open price of the tradeable asset. For example, node 716 has a large node size, indicating that the value of the asset has significantly increased since the market open price of the asset. In contrast, node 714 has a small node size, indicating the value of the asset has marginally decreased since the market open price of the asset. Further, the size of the nodes may be segmented into a plurality of sizes. For example, the nodes may be segmented into a small size correlating to a change between a change between (±) 0%-0.5%, a medium size correlating to a change between a change between (±) 0.5%-1%, a large size correlating to a change between a change between (±) 1%-4%, and an extra-large size correlating to a change between a change between (±) 4%.

Additionally, the tradeable assets may have a fourth characteristic indicative of a recommended trading action. Similar to the recommendation described in FIG. 5, the recommended trading action may correlate to a buy recommendation, a sell recommendation, or a hold recommendation. For example, the asset corresponding to node 722 may have a buy recommendation because of the large positive trading momentum and large volume. Additionally, the asset corresponding to node 714 may have a sell recommendation because the asset is rapidly losing value and has a large volume. Additionally, the asset corresponding to node 718 may have a hold recommendation the asset is not rapidly losing value. In some examples, the buy recommendation may be a green node, the sell recommendation may be a red node, and the hold recommendation may be a yellow node.

A fifth characteristic may also be indicative of the daily price change of the tradeable asset, with nodes exhibiting a visual indicator. For example, the visual indicator of the nodes may be a color, with yellow correlating to a ±0.5% change, green correlating to a change above 0.5%, and red correlating to a change below −0.5%. Further, the intensity (or darkness) of the node may indicate a greater percentage change. For example, a dark green node would correlate to a change significantly greater than 0.5%, and a light (or faint) red node would correlate to a change at (or slightly above) −0.5%.

A sixth characteristic may also be indicative of the daily price change of the tradeable asset, with nodes exhibiting an audio indicator. For example, the audio indicator of the nodes may be a sound, with a bird (or chirping) sound correlating to a positive change, a beeping sound correlating to a negative change, and no sound correlating to no (or an insignificant) change. Further, the intensity (or darkness) of the sound may indicate a greater percentage change. For example, a rapidly chirping sound would correlate to significant positive change (e.g., greater than 5%), and a slow (or intermittent) beeping sound would correlate to a slight negative change (e.g., less than 0.5%).

A seventh characteristic may be indicative of one or more performance indicators of the tradeable asset. While the tradeable assets are generally presented as nodes, the tradeable assets may be presented in other shapes corresponding to a performance indicator. Additionally, the shapes of the performance indicators may also include visual indicators, as described above. The performance indicators may include a Bollinger Band, V-Weighted Average Price (VWAP), Relative Strength Index (RSI), and Intraday Momentum Index (IMI). In one embodiment, the Bollinger Band indicator is represented by a triangle shape, the VWAP is represented by a square shape, the RSI is represented by a hexagonal shape, and the IMI is represented by a diamond shape. For example, when the upper and lower Bollinger Bands are close together (e.g., bandwidth), the visual indicator of the triangle will appear green, indicating low volatility. On the other hand, when the upper and lower Bollinger Bands are far apart (e.g., bandwidth), the visual indicator of the triangle will appear red, indicating high volatility. When the VWAP is above the current trading price of the tradeable asset (i.e., undervalued), the visual indicator of the square will appear green. Alternatively, when the VWAP is above the current trading price of the tradeable asset (i.e., overvalued), the visual indicator of the square will appear red. When the RSI of the tradeable is below a first threshold value (e.g., 30), the visual indicator of the hexagon will appear green. Alternatively, when the RSI of the tradeable is above a second threshold value (e.g., 70), the visual indicator of the hexagon will appear red. Similarly, when the IMI of the tradeable is below a first threshold value (e.g., 30), the visual indicator of the hexagon will appear green. Alternatively, when the IMI of the tradeable is above a second threshold value (e.g., 70), the visual indicator of the hexagon will appear red. It is understood that the user may be able to set the threshold values for the performance indicators. In another embodiment, the visual indicator may be a star-shape when multiple performance indicators are triggered.

### Artificial Intelligence

In each of the above-described characteristics for the tradeable assets/nodes, artificial intelligence (AI) may be employed to manage the user's investments based performance. The AI may suggest trading recommendations based on, for example, the user's trading tendencies. For example, the AI may provide buy or sell recommendations for the user's tradeable assets based on the user's historical threshold values of performance indicators. Additionally, the AI may provide buy or sell recommendations for the user's tradeable assets based on the user's historical actions with the same asset or similar assets. For example, the AI will understand when the user prefers to buy or sell at certain trading momentum speed, momentum direction, percent change in price, etc.

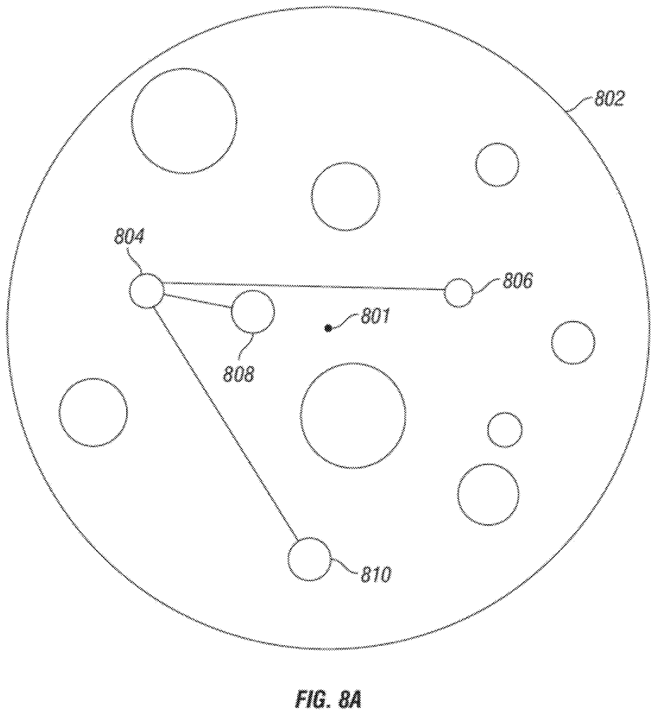

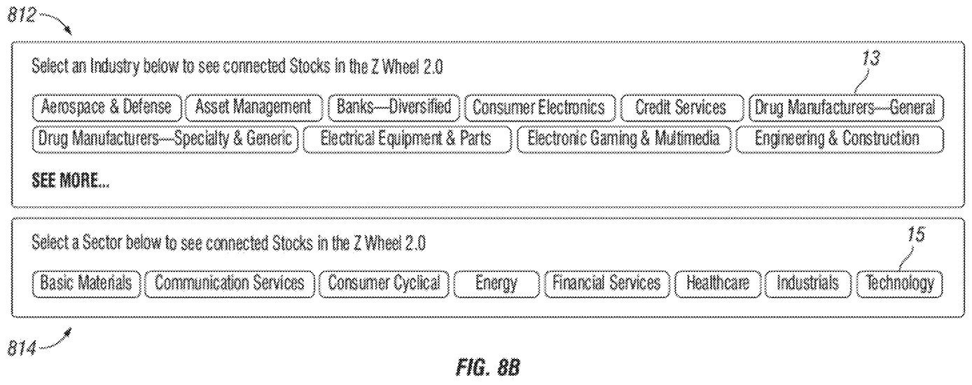

Referring to FIG. 8A and FIG. 8B, illustrations of a connection indicator between tradeable assets corresponding to industries and sectors are illustrated. The user may select a node within the circular common area 802 to identify assets that are part of the same industry 812 and/or sector 814. For example, if the user selects node 804 and the drug manufacturing industry 813 or technology sector 815, the dynamic interface displays the connection indicator between node 804 and nodes 806, 808, and 810. The connection indicator provides the user with a quick assessment of which of their assets are in their portfolio, how those assets are trading, and the size of their position in the industry or sector relative to the portfolio. The industry may be, for example, aerospace, asset management, banking, consumer electronics, credit services, drug manufacturing, electrical equipment, multimedia, engineering, and construction. The industry may be, for example, basic materials, communication services, consumer cyclical, energy, financial services, healthcare, industrials, and technology.

### Exemplary Interface With Tradeable Asset Classes

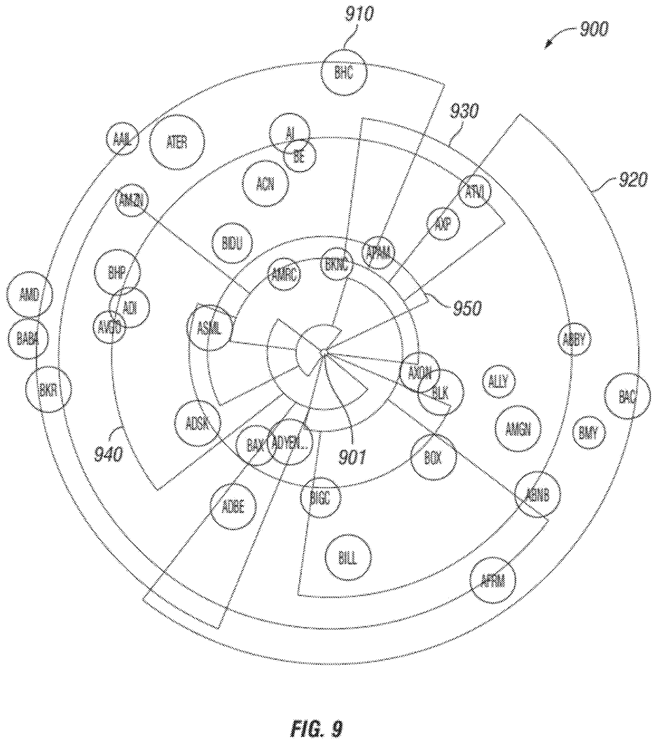

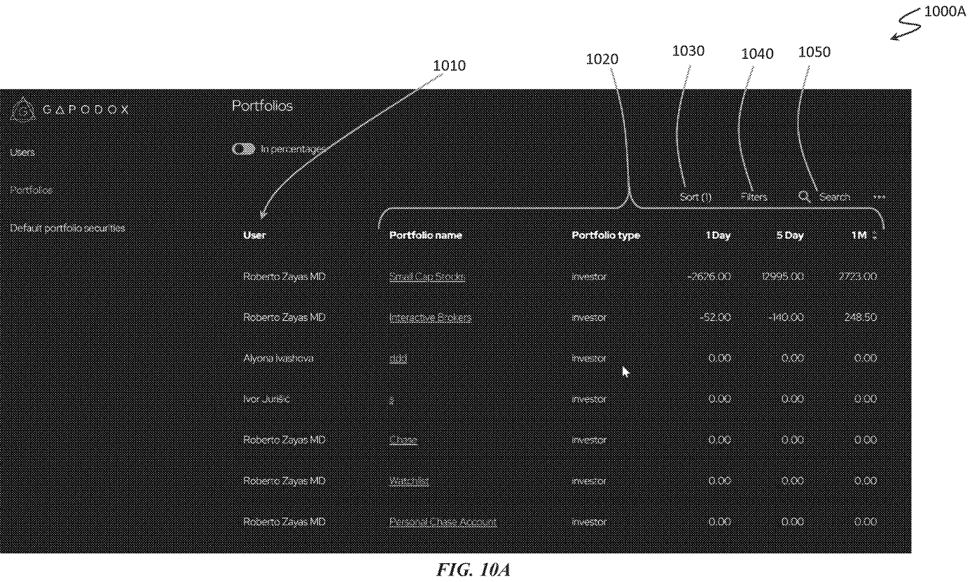

FIG. 9 is an illustration of a dynamic interface 900 of a plurality of wedges representing tradeable asset classes. The dynamic interface 900 comprises a plurality of nodes 910 disposed within a common area. The dynamic interface 900 further comprises a plurality of wedges 920, 930, 940, and 950 arranged within the common area. The plurality of wedges 920, 930, 940, and 950 correspond to various asset classes. The plurality of wedges 920, 930, 940, and 950 revolve around a center point 901 of the common area. The plurality of wedges 920, 930, 940, and 950 comprise characteristics based on the data of the asset classes. A first characteristic may be indicative of a volume of the tradeable assets within the asset class relative to the portfolio is the size of the wedge. Wedges with larger sizes correspond to the user holding a large amount of tradeable assets within the class relative to the portfolio. In contrast, wedges with smaller sizes correspond to the user holding a small amount of tradeable assets within the class relative to the portfolio. For example, wedge 920 is larger than wedge 950, indicating that the user holds significantly more assets corresponding to the class in wedge 920 than those in wedge 950.

A second characteristic may be indicative of a trading momentum of an asset class. Similar to nodes described in FIGS. 7A and 7B, the wedges of the asset class have an angular movement based within the common area, with the direction indicating how the class is trading (e.g., asset class is increasing or decreasing in value). Asset classes having a positive trading momentum have a clockwise angular movement, with the speed of the angular movement increasing with a larger positive trading momentum value. Asset classes having a negative trading momentum have a counterclockwise angular movement, with the speed of the angular movement increasing with a larger negative trading momentum value.

A third characteristic may be indicative of a recommended trading action. Similar to the recommendation described in FIGS. 7A and 7B, the recommended trading action may correlate to a buy recommendation, a sell recommendation, or a hold recommendation. In this example, a buy recommendation for a particular asset class corresponds to recommending that the user increase their position in the assets already in their portfolio. Alternatively, a buy recommendation for a particular asset class corresponds to recommending that the user purchase additional assets within the class that are not already held in their portfolio. Similarly, a sell recommendation for a particular asset class corresponds to recommending that the user decrease their position in the assets already in their portfolio. In some examples, the buy recommendation may be a green wedge, the sell recommendation may be a red wedge, and the hold recommendation may be a yellow wedge. The asset class may be pharmaceutical, social media, electric vehicles, and energy.

In another embodiment, the dynamic interface 900 may further be configured to present additional information of a tradeable asset and/or tradeable asset class. For example, by hovering over a node or wedge in the dynamic interface 900, a user will be able to view detailed information about the asset, which is advantageous because a user can further investigate an asset after identifying on the dynamic interface 900 because of its characteristics. Detailed information may include Bollinger Band values, VWAP, RSI, IMI, share price, share price change, and percent change in share price.

### Socialization

The dynamic interface 900 may further be configured for socialization such as to present shared top performing portfolios of other traders and/or the shared portfolio of traders the user is following. Such sharing of portfolios with other users provides socialization that enables traders to view the shared or presented portfolios of others. Such socialization of portfolios permits a user to follow other users to improve their own portfolio performance. A user can share their portfolio with other users via email. In at least one embodiment of such socialization, the dynamic interface 900 may be configured to display the common holdings of every shared portfolio or portfolio the user is following. A common holding may be any predetermined number (e.g., 1 or more) set by the user. For example, by setting the common holding threshold at 2, the dynamic interface 900 would present every tradeable asset that at least two other traders are currently holding. An advantage of this presentation is that the user is able to determine common assets that are held by other traders and assess the assets on a single screen, thereby increasing the efficiency of the decision-making process.

### Artificial Intelligence

In each of the above-described characteristics for the tradeable assets/wedges, artificial intelligence (AI) may be employed to manage the user's investments based on performance. The AI may suggest trading recommendations based on, for example, the user's trading tendencies. For example, the AI may provide buy or sell recommendations for the user's tradeable assets based on the user's historical threshold values of performance indicators. Additionally, the AI may provide buy or sell recommendations for the user's tradeable assets based on the user's historical actions with the same asset or similar assets. For example, the AI will understand when the user prefers to buy or sell at certain trading momentum speed, momentum direction, percent change in price, etc.

### Gamification

The embodiments of the above-described interface 500 and dynamic interface 900 may be combined with “gamification” features. Any of a variety of ways to “gamify” these embodiments can be used, for example, to encourage feedback, to reward users for attaining a status level (e.g., labeled as a top or successful trader), competition among users, to simply encourage more use of the platform or service in general, to encourage collaboration between users, and/or enable users to monetize their trading skills. In some embodiments, a leaderboard can be generated that identifies some top performing portfolios and related metrics and which is displayed to users.

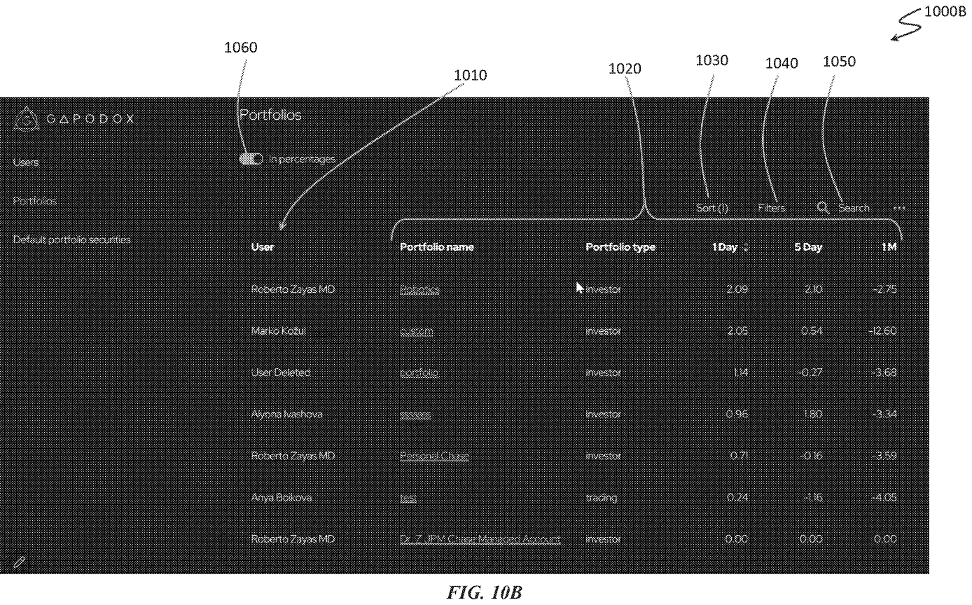

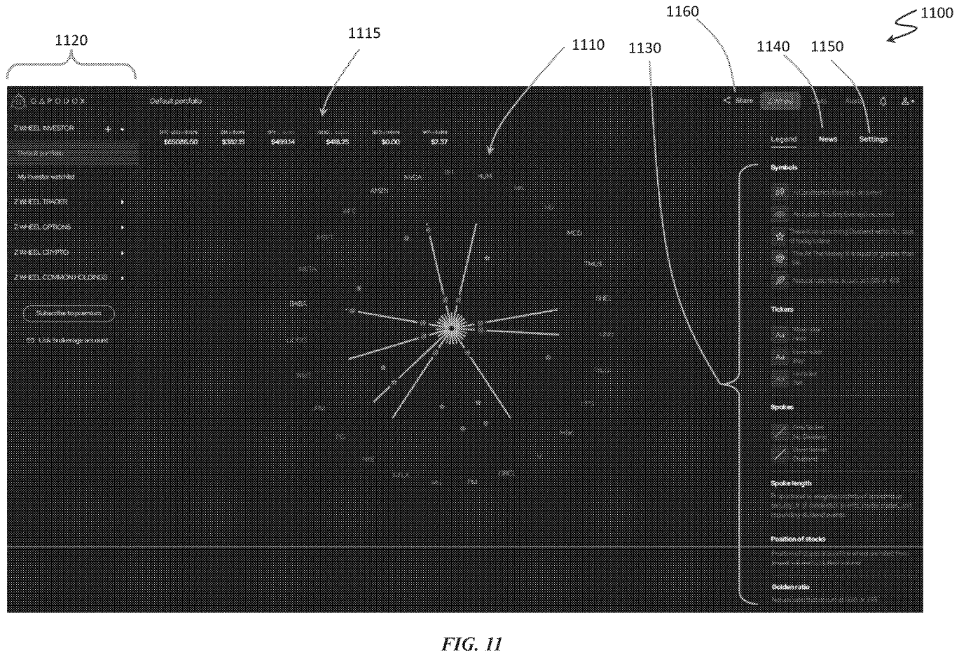

Looking at FIGS. 10A-10B, illustrated are screenshots setting forth exemplary leaderboards of ranked users/traders. FIG. 10A illustrates a screenshot 1000A of a leaderboard of users/traders 1010 where the ranking on the leaderboard is done based on increases or decreases in dollar values of portfolios being ranked. The list of the users/traders on the leader board is provided under a “User” column 1010. Data 1020 for each ranked portfolio is provided in associated columns corresponding to each row of user/trader. Exemplary metrics for ranking users/traders on a leaderboard may include the number of stocks in the portfolio, the average return for the portfolio, and total portfolio value, and thus the position or ranking of each user's portfolio among these shared portfolios.

In the illustrated screen 1000A of FIG. 10A, the displayed data 1020 includes the portfolio name, which may be provided by the users, and the portfolio type. Additionally, the dollar value gained or lost for each portfolio held by each ranked user is provided for a plurality of timeframes. In this illustrated embodiment, the dollar value gains or losses are provided for 1 Day, 5 Day, and 1 Month time periods. In similar embodiments, additional columns for any other periods of time may also be provided, such as 3 Months, 6 Months, and 1 Year intervals. The leaderboard of dollar values may be sorted by any one of these time periods, which in turn re-ranks the users along the leaderboard. As such, one leaderboard for the most gained in 1 Day can be created, while a different leaderboard for the most gained in 1 Month can then be created. Also, the rankings may be sorted greatest to least or vice versa by clicking the appropriate icon at the top of each column. In other embodiments, instead of gains/losses over certain periods of time, the overall value of each portfolio for a predetermined or selected period of time may be used to rank the leaderboard of users. Additionally, a column giving the viewing user an option to “follow” or “unfollow” each of the ranked portfolios may also be provided. Additionally, an icon or hyperlink may be associated and displayed with the ranked portfolios, whereby selecting (e.g., clicking or hovering over it with a cursor) causes display, to the user or perhaps just a user “following” a ranked portfolio, of one or more tradeable assets within the associated portfolio, and/or display of details regarding buying, selling, and/or holding activities of one or more tradeable assets within the associated portfolio.

The ranked users or portfolios may be altered by using a “Sort” button 1030, where various additional metrics can be used to sort users or portfolios. Information and portfolios may also be filtered by the viewing user using a “Filters” button 1040. Not only may the ranked results be viewed, but also the metrics and measures by which the leaderboard of users or portfolios are ranked may be altered as well. Such filters may be used to change the ranking columns being displayed and employed to generate a leaderboard. Leaderboards such as the one illustrated in FIG. 10 may be created by the platform or users. For example, the platform may provide default dynamic leaderboards for any of a number of categories, such as overall portfolio value or performance of all users of the platform over the exemplary periods discussed above, and which may be measured by any of a number of time frames or even simply on the current day the leaderboard is viewed by a user. Leaderboards may also be provided based on just the users “followed” by the viewing user. Default leaderboard ranking may be set by the platform, such as portfolio value or gain across a certain period of time, and then adjustable by the user as desired.

FIG. 10B illustrates a screenshot 1000B of a leaderboard of users/traders 1010 where the ranking on the leaderboard is done based on increases or decreases in percentage increases or decreases of portfolios being ranked. To create such leaderboards, a user can turn on an “In percentages” button 1060 that ranks the users or portfolios in percentage increase or loss in value over one or more of the plurality time periods discussed above. The list of the users/traders on such leaderboards is again provided under a “User” column 1010, while the data 1020 identified above for each ranked portfolio is provided in associated columns corresponding to each row of user/trader. The Sort 1030, Filters 1040, and Search 1050 are again also available to a viewing user to manipulate the displayed information in the screen 1000B.

Beyond the illustrated embodiments in FIGS. 10A and 10B, the ranking of performance of traders/users can be based on any of a number of such metrics or other classes, categories, groupings, etc. For example, a leaderboard could be of the top traders based on overall portfolio value or overall return-on-investment (ROI), the top traders (in volume or gain) for any user-selected period of time, the top traders among a certain profession or group of users, such as notable stockbrokers, celebrities, certain demographic(s) (e.g., top traders under-25 or top female traders), top traders within a certain class of investment (e.g., technology stocks versus energy stocks versus commodities versus cryptocurrencies), or any other measure of status possible. Any of these or other possible measures of portfolio performance may also provide a reward of some type of those users/traders on a particular leaderboard. Such reward system may be simply monetary awards paid to certain leaderboard portfolios, or may be based on a reward system unique to the platform. Such reward system may include awarding and accumulating “points” or other measure of value unique to the platform, where certain numbers of points can be redeemed with the platform for something in return, such as free or reduced-cost access to certain paid features of the platform. In still other embodiments, mere “bragging rights” may be the reward for moving up the ranks of a particular leaderboard, especially leaderboards formed of followed users or a group of users who are otherwise friends and are engaged in friendly competition on the platform.

### Monetization

In one embodiment, users can charge others to access their portfolio (e.g., view their interface 500 and/or dynamic interface 900, or any interface and related portfolio as disclosed herein). This monetization aspect is advantageous when a user has developed a reputation as a successful trader and gained attention (or followers), thereby increasing the amount of money or other reward a user can make for allowing access to their portfolio. In some embodiments, a user can charge a fee for another user requesting access to follow the portfolio. In exemplary embodiments, the fee charged by a user to share their portfolio or interface with a paying user can be predetermined based on the leaderboard ranking of a user among multiple shared portfolios visible to the user. In some embodiments, the fees charged by users is increasing as their portfolio rises up the leaderboard. Additionally, in some embodiments, users may be encouraged/rewarded for posting/sharing their portfolios, for example, to see if other users are interested in their investments. Still further, rewards for sharing a portfolio may be paid by the platform, with or without rewards being paid by following users.

In some embodiments, displaying the leaderboard of organized portfolios and the users associated therewith includes displaying organized portfolios having a collectable value of tradeable assets substantially similar as collectable values of tradeable assets of other users to whom the leaderboard is displayed. In such embodiments, the leaderboard may be limited to displaying such substantially similar portfolios. Such limitation may be advantageous to users “following” shared portfolios of substantially similar collective value because it permits the following user to more closely related their portfolio to the followed portfolio, and thus any copying of the followed, shared portfolio is more closely related to buying, selling, and/or holding activities that may be implemented in their own portfolio. For example, while following a shared multi-billion dollar portfolio may be entertaining to a following user, the activities taken with assets in that shared portfolio may not translate into similar activities the following user could take with the assets in their own portfolio. Similarly, following a large value portfolio that experiences substantially large changes in monetary value or percentages of values may again not translate into actions the following user could take with the assets in their own portfolio. In such cases, the large changes in monetary or percentage of value is typically indicative of a high level of risk or risk tolerance by the owner of that high-changing portfolio. As such, the following user may not have the same risk tolerance as that owner sharing their portfolio, and thus the risky actions taken with assets in that portfolio would again not likely be an acceptable level of risk to the following portfolio owner.

Moreover, as with all portfolios associated with a platform hosting an interface as disclosed herein, owners may choose to share their portfolios with one or more other users for free or for payment of a fee or other reward. For example, an owner may choose to share their portfolio and details associated therewith with friends and family for free or a smaller fee/reward, than the fee or reward to be paid by other users of the platform. Also, any sharing of portfolios may be only for a predetermined amount of time, which may or may not be in proportion to the amount of a fee or reward paid to the owner by the platform and/or other users. In some embodiments, such a reward is associated with publication of information, e.g., on the platform, regarding trading of tradeable assets within the shared portfolio by the owner/rewarded user. Such shared information or details may comprise sharing buying, selling and/or holding activity of tradeable assets in the shared portfolio by the owner or the owner's representative. An amount of reward paid to the sharing owner may be in proportion to the amount of details/information being publicly shared by the sharing owner.

### Additional Exemplary “wheel” Interfaces

FIG. 11 illustrates a screenshot 1100 of an exemplary “wheel” interface 1110 that concurrently displays graphical representations of numeric data and transaction data relating to a portfolio of tradeable assets. In this example, the tradable assets are publicly traded companies, such as Amazon (AMZN) and Nvidia (NVDA). As such, this wheel interface 1110 is a display for an “investor”, as denoted in the selectable menu 1120 on the left side of the display screen 1100. While the illustrated interface 1110 is a “default portfolio” of tradable assets, which may be selected by an administrator of interface platform/site (e.g., GAPODOX, in this embodiment), such an investor may select the specific tradable assets they prefer to see simultaneously displayed on the interface 1110. This option may be selected using the “My investor watchlist” button in the menu 1120.

Additionally, the exemplary screen may also display one or more selected tradable assets 1115 along the top of the screen, for easy reference to the user. The specifics assets being displayed may be selectable by the user, or may be chosen by an administrator. The information of these assets displayed may also be selectable, where in the illustrated embodiment the current value of each asset is displayed. In some embodiments, the displayed assets may be based on the portfolio of the particular user, such as the best performers of the user's portfolio, or perhaps the most valuable. Moreover, the number of such assets may be selectable, or no assets displayed at all. Further, the assets display may be revised in real-time as the user hovers over a part of the wheel interface, or perhaps clicks on certain assets to view.

As with the interface embodiment shown in FIG. 5, the interface 1100 in FIG. 10 the plurality of tradable assets/companies (shown by their ticker symbol) in the displayed portfolio are arranged about a periphery of a plurality of concentrically-aligned annular regions. Information pertaining to each ticker symbol is designated by placement of one or more graphical elements in the annular regions, extending in a radial direction from an origin (i.e., at the center of the wheel interface) towards the respective ticker symbol. Placement of the ticker symbols may be indicative of the volume of the tradeable assets corresponding to the ticker symbols. In one embodiment, the placement of the ticker symbols is indicative on increasing volume, with volume increasing in a clockwise direction. In another embodiment, the placement of the ticker symbols is indicative on increasing volume, with volume increasing in a counterclockwise direction.

Also as before, the interface 1100 may further include lines extending from the origin toward each ticker symbol. The lines can be dividend symbols that include at least: (i) a first variable aspect, and (ii) a second variable aspect. An example of the first variable aspect can be an appearance of the line (such a different colors) that graphically indicates whether or not a dividend is paid to holders of the tradeable asset. While in the interface of FIG. 5 solid versus broken lines, as well as light versus heavy line weights, provided such indications, in the interface 1100, line colors are used to provide such information. The second variable aspect of the lines can graphically indicate a relative quantity of events that occurred, or are scheduled to occur involving the tradeable assets displayed on the interface 1110. For example, the longer the line, the greater the number of events that have occurred, or are scheduled to occur involving the tradeable assets. However, other graphical aspects of the line such as a color code, a size, a shape, or any other graphical element can be utilized as the first variable aspect.

According to some embodiments, examples of the events include, but are not limited to: candlestick events, insider trades, impending dividend events, any other event, and any combination thereof. In this exemplary screen 1100, a Legend 1130 is provided along one side of the display screen to explain to a user what certain symbols mean for a particular asset. Such symbols can be arranged within the annular regions in the radial direction extending from the origin to the respective ticker symbol. For example, a marker such as the “at” symbol (@) can be placed in an annular region, which can be designated for markers that identify tradeable assets for which the “at the money” percentage exceeds a percentage specified in the configuration package, which may be user-defined. The “at the money” percentage is a percentage of the outstanding options for a tradeable asset that, at the current market price, is within a defined tolerance of the option strike price. In the illustrative embodiment of FIG. 11, the defined tolerance was again specified as five (5%) in the configuration package. Similarly, another or the same annular region can be designated to display markers such as a star (★), which is indicative of an upcoming dividend payment within a predefined period (perhaps by the user as well) from the date on which the numeric and transaction data is received by the aggregation module 112. In the example of FIG. 11, the stars (★) indicate that five tradeable assets have an upcoming dividend payment within the next thirty (30) days.

A display markers that is an eye may also be used in one or more of the annular regions to indicate that an insider trading event has occurred. As mentioned above, insider trades involve a transaction involving the respective tradeable asset by a party who has information that is not available to the general public. Whether an insider trading event has occurred is determined by the display driver module based on transaction data received by the aggregation module. Also as before, a display marker that is a candlestick marker may also be displayed in an annular region to indicate a candlestick event has occurred, which are explained above. Any one or more of the visual indicators described above for other embodiments of a wheel interface in accordance with the disclosed principles may also be included on the wheel interface 1110 of FIG. 11. For example, a natural ratio marker (shown in the Legend 1130) may be displayed on the interface 1110 based on the correlation of the trading movement of a tradeable asset and the Fibonacci sequence. As described in detail above, the natural ratio is obtained by diving successive pairs of Fibonacci numbers, yielding approximately 1.618 (or conversely 0.618). The natural region may utilize Fibonacci retracements, Fibonacci arcs, Fibonacci fans, Fibonacci zones, or any combination thereof to determine the natural ratio for a tradeable asset. The determination may also utilize other methods known in the art. For example, an annular region may be designated to display markers indicative of a strong or weak performance for a tradeable asset correlated to the natural ratio based on the received data. If an asset is projected as performing better in the future, an indication may be presented notifying the user that the tradeable asset will be entering a historically better performing period. Alternatively, a different indication may be presented notifying the user that the tradeable asset will be entering a historically weaker performing period if projected to lose value.

Aside a clickable “Legend” button used to display the Legend 1130 are a “News” button 1140 and a “Settings” button 1150. Clicking the “News” button 1140 replaces the displayed Legend 1130 information with current or at least recent important news stories or blurbs regarding the tradeable assets being displayed on the wheel interface 1110. In some embodiments, such news information may be provided as clickable links which when clicked accesses the source providing the news information. In other embodiments, selecting a news blurb may display a pop-up with the full news story or other information. Similarly, next to the News button 1140 may be a “Settings” button 1150. Clicking this button may then display a number of options for the user to select that affects the information displayed on the wheel interface 1110. For example, which tradeable assets being displayed may be altered by the user, as well as the particular information being displayed about each of the displayed tradeable assets. Other settings may include timeframes for displaying asset information on the interface 1110, as well as labels to add to and display on the interface 1110 such as price, volume, etc. There may also be provided an option to set the user's interface as “public” where sharing will all users of the platform is provided. Of course, other general settings may also be accessed by the user, such as altering screen colors, fonts, sizes, etc. used to present the wheel interface 1110.

As before, the wheel interface 1110 may further be configured for socialization by the user electing to share his interface/portfolio by selecting a “Share” button 1160. Electing to share his interface/portfolio may be made as an open request for any other user to accept (or ignore), or it may be done in response to specific requests by other users to view the user's interface/portfolio. For example, pressing the “Share” button 1160 may access a screen that displays any requests by other users for access to the user's interface/portfolio, and the user may then elect which request to acquiesce to, as desired. Such requests may be made through the platform, such as via messaging or chat, or may be in response to a received communication such as an email request. Such sharing in response to a request may be manifested as an acceptance by other users to “follow” the user's interface/portfolio as well. Such sharing of portfolios with other users provides socialization that enables traders to view the shared or presented portfolios of others, and which thereby permits users to follow other users to improve their own portfolio performance. Socialization may also include any of the embodiments and features discussed herein. Socialization may further include facilitating communication between the owner of the shared/follower portfolio and the following user. Such communication may be via a chat or message feature provided by the platform. Moreover, AI may again be employed in this embodiment of the wheel interface 1110 in any of the manners and embodiments discussed above, including providing suggests to a user of what other users to follow based on any one or more characteristics determined by the AI as being beneficial for the user to follow.

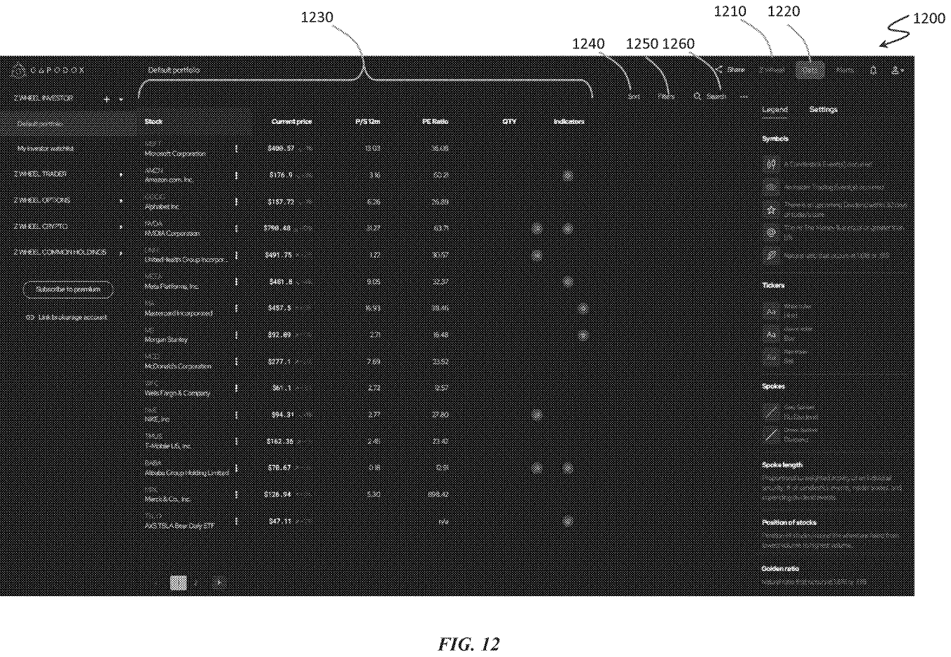

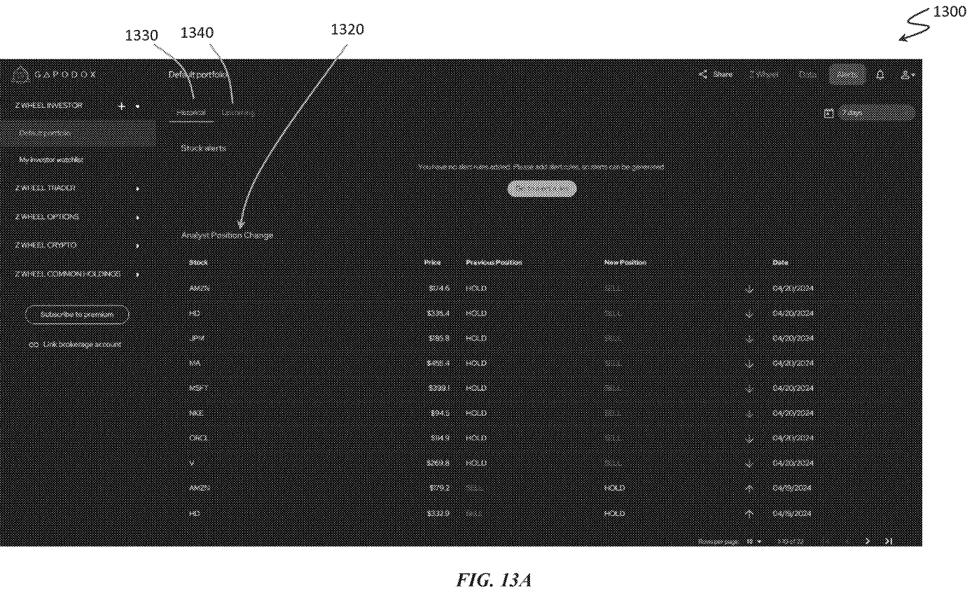

While presentation of the wheel interface 1110 is provided to a user when selecting the “Z Wheel” button 1210, adjacent to this button is a “Data” button 1220. FIG. 12 illustrates a screenshot 1200 displaying information to a user when the “Data” button 1220 is selected. For example, as illustrated the displayed data may be organized in rows, where each row is dedicated to a particular tradeable asset, such as the stocks shown. Columns may then be provided for each row to provide certain information, such as current price, quantity of assets owned by the use, visual indicators corresponding to those displayed on the wheel interface 1110, and any other information or data useful to users regarding the type of tradeable assets being presented. The presented data in the columns may be sorted as desired with a “Sort” button 1240, as well as filtered by a “Filter” button 1250. Also, a user may search for a particular tradeable asset using a “Search” field 1260. While the same Legend 1130 is provided along the side of the screen 1200, once again selecting the “Settings” button 1150 can access various items the user may select or change in order to alter the data being displayed in the columns for each tradeable asset.

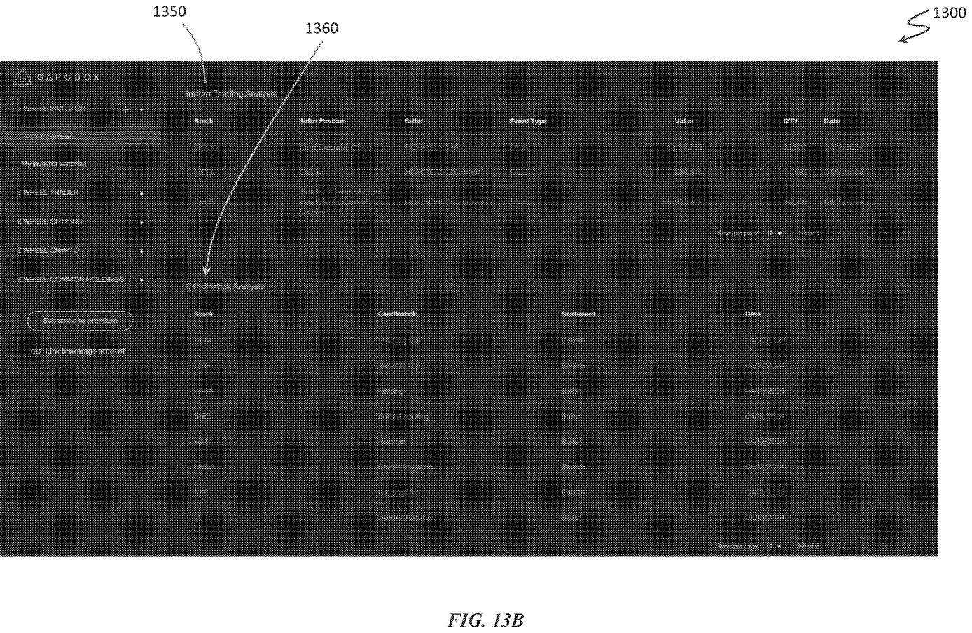

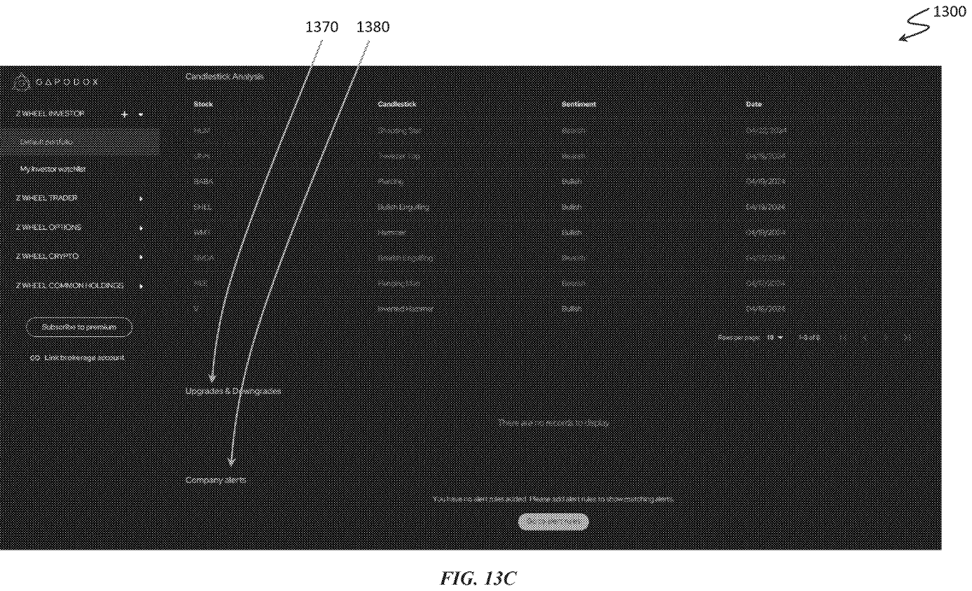

Looking now at FIG. 13A, illustrated is a screenshot 1300 displaying exemplary alerts displayed to a user regarding the tradeable assets in his portfolio, or perhaps tradeable assets the user simply elects to follow. This screen is accessible by the user selecting an “Alerts” button 1310 located adjacent to the “Data” button discussed above. As illustrated, a first portion of the alerts screen 1300, entitled “Analyst Position Change” 1320, provides information regarding the increased or decreased value of one or more tradeable assets, or perhaps suggestions by the platform (either via AI or tracking of other users'actions regarding the same or similar tradeable assets) of what to do with a tradeable asset (e.g., sell, buy, or hold). Such alerts may be customizable by users using “Alert Rules” or other settings, or may be provided as default alert settings set by the platform or an AI engine affiliated with the platform. Both a “Historical” tab 1330 and an “Upcoming” tab 1340 may also be provided to permit the user to view prior alerts as well as upcoming alerts, respectively, selectable for specified periods of time.

FIG. 13B illustrates a lower portion of the “Alerts” screenshot 1300 introduced above. In this scrolled-down portion of the Alerts screen 1300, additional alerts are displayed to a user. In the illustrated embodiment, an “Insider Trading Analysis” section 1350 displays information to the user pertaining to known or perceived “insider trading” events regarding certain tradeable assets. Another section 1360 of the screen 1300 displays information to the user pertaining to “candlestick” events regarding certain tradeable assets. FIG. 13C illustrates a further lower portion of the screen 1300 of FIGS. 13A and 13B. This lowest area of the screen 1300 includes an “Upgrades & Downgrades” section 1370, as well as a “Company alerts” section 1380, where both sections can provide relevant alerts and accompanying information to the user.

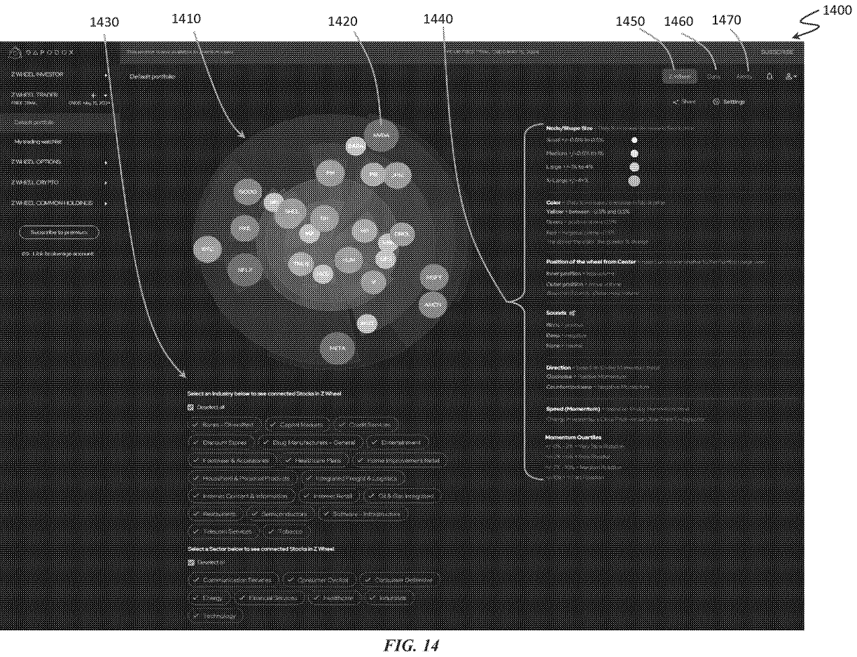

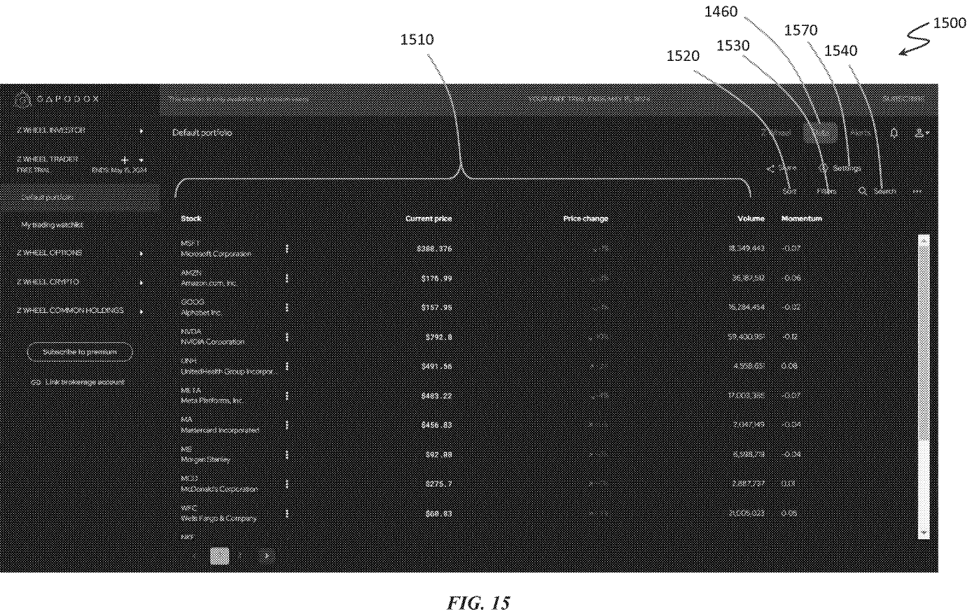

Turning now to FIG. 14, illustrated is a screenshot 1400 of another embodiment of a dynamic wheel interface 1410, where this wheel interface 1410 provides a dynamic visual representation tracking a plurality of tradeable assets. In this “Trader” wheel 1410, the tradeable assets being tracked may or may not be tradeable assets held by the user viewing the interface 1410, but instead are assets selected by the user to dynamically track. Similar to the interface 900 illustrated in FIG. 9, this interface 1410 displays a plurality of tradeable assets, in this case stocks again, illustrated on a plurality of wedges within the wheel interface 1410. Each tradeable asset is displayed as a node 1420 within a wedge and at a specific radial position on the wheel interface 1410. While a “default portfolio” is displayed via the interface 1410, a subscribing user may make his own selections for display on the interface 1410 by clicking the “My trading watchlist” option from the left-side menu.

The wheel interface 1410 also again incudes a plurality of wedges arranged within and revolving dynamically around the center of a common area. Each of the wedges corresponds to various asset classes, and the shape, size, and movement of the wedges comprise characteristics based on data regarding each of the asset classes. As before, the size of a wedge may correspond to a first characteristic indicative of a volume of the tradeable assets within the asset class. In this illustrated embodiment, wedge size corresponds to the user's holding of the tradeable assets within the class for that wedge. In contrast, wedges with smaller sizes correspond to the user holding a smaller amount of tradeable assets within the class relative to his portfolio. Accordingly, a wedge significantly larger than another illustrated wedge indicates that the user holds significantly more assets corresponding to the class in first wedge than those in second, smaller wedge. Selectable asset classes are provided in a clickable list 1430 underneath the displayed wheel interface 1410. From this list 1430, the user can select which class of assets to display on the wheel interface 1410, with such selection(s) being displayed in real-time on the interface 1410.

Another “Legend” 1440 is displayed along the right-side of the interface 1410, and which explains the meanings of the various symbols, colors, movements/velocities, and sizes/shapes of items displayed on the interface 1410. Again a Settings button is provided where the user is permitted to adjust various settings affecting the display of the interface 1410 as well as other parts of the screen 1400. A Share button is also again provided to permit the user to share his interface 1410 with other users, which can again be a general selection to make his interface 1410 publicly viewable or may be selected sharing with only certain other users. In either case, as described in detail above, the user may be rewarded for his sharing of his interface 1410, whether the reward is monetary or in the form of some other benefit provided to the user, such as reduced or waived subscriber fees to the platform. Where monetary payments are awarded to the user, such money may be paid to the user from the platform, from users wanting access to the user's interface 1410, or both. In some embodiments where payment is made from other uses to the sharing user, the platform may monetize such arrangements by receiving a portion of the monies paid to the sharing user. Moreover, the amount of monies paid to a user for sharing or making their interface publicly available to other users may be based on the success of the sharing user and/or some other measure(s), such as the status of the sharing user, the portfolio value of the sharing user, the financial success of the sharing user within a predefined time frame, or any other measure(s) against which the sharing user may be compared to other users of the platform. Such measure(s) may further affect the monetary reward paid to the sharing user, as well.

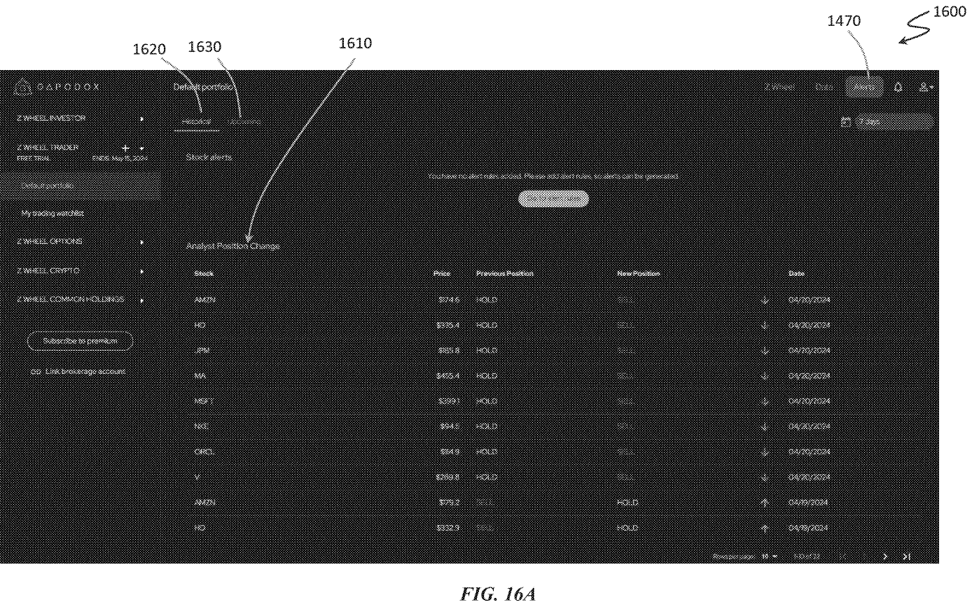

While the dynamic wheel interface 1410 is visually displayed on the screen 1400 when the “Z Wheel” button 1450 is selected, the viewing user may also temporarily navigate away from the displayed interface 1410 by selecting the “Data” button 1460 or the “Alerts” button 1470, with similar information being respectively provided by each in substantially the same manner as described above. For example, FIG. 15 illustrates a screenshot 1500 displaying information to a user when the “Data” button 1460 is selected. The displayed data 1510 may again be organized in rows, where each row is dedicated to a particular tradeable asset, such as the stocks shown in the interface 1410. Columns may then be provided for each row to provide certain information, such as current price, change in price, volume of assets owned by the user, and momentum of the assets displayed on the wheel interface 1410, and any other information or data useful to users regarding the type of tradeable assets being presented. The presented data in the columns may again be sorted as desired with a “Sort” button 1520, as well as filtered by a “Filter” button 1530 as described above. Also, a user may search for a particular tradeable asset using a “Search” field 1540. Once again selecting the “Settings” button 1570 can access various items the user may select or change in order to alter the data being displayed in the columns for each tradeable asset.

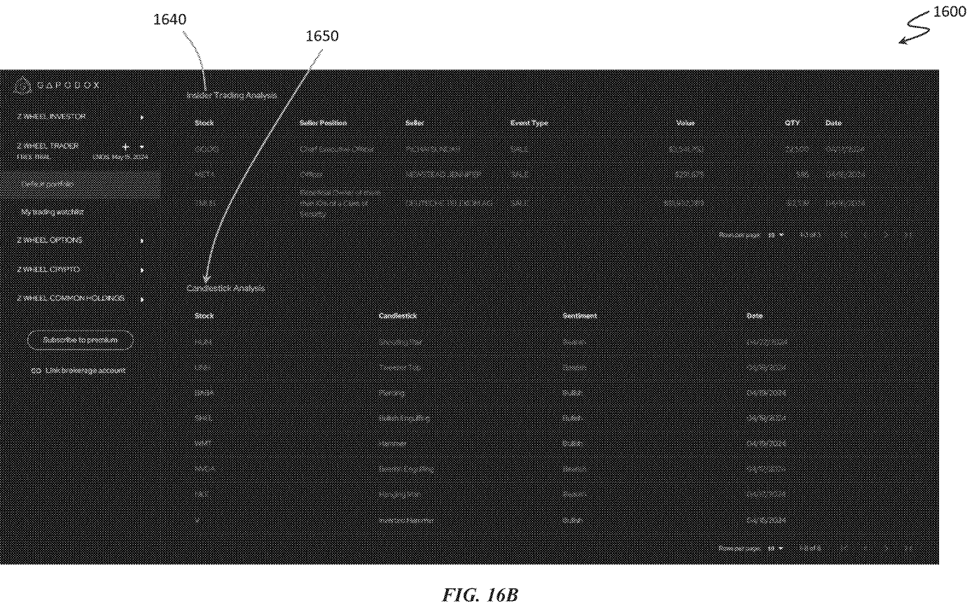

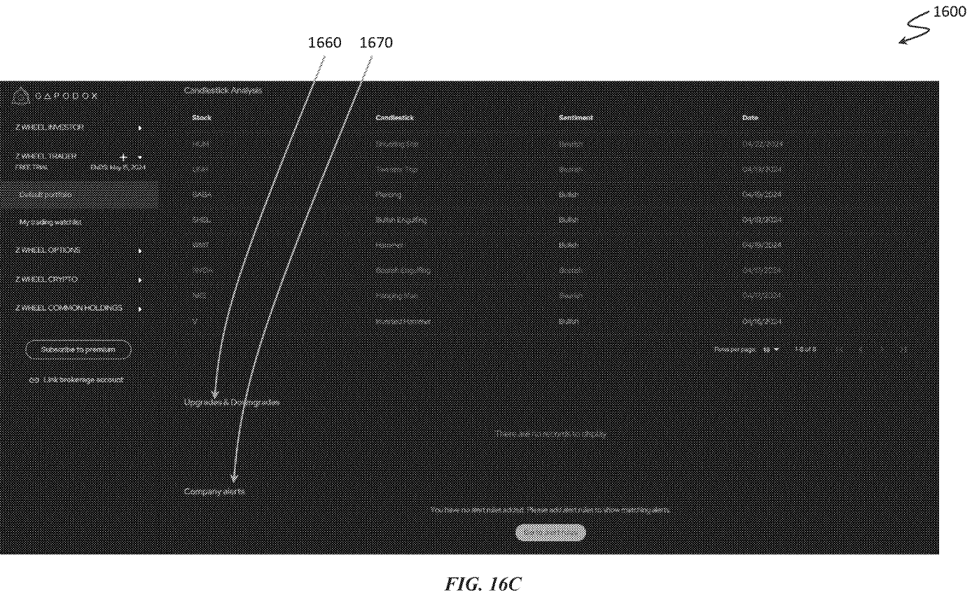

Looking now at FIG. 16A, illustrated is a screenshot 1600 displaying exemplary alerts to a user regarding the tradeable assets displayed in the interface 1410 when the “Alerts” button 1470 is selected. As with the exemplary Alerts screen discussed above, a first portion of the alerts screen 1600, entitled “Analyst Position Change” 1610, provides information regarding the increased or decreased value of one or more tradeable assets from the interface 1410, or perhaps suggestions by the platform (either via AI or tracking of other users'actions regarding the same or similar tradeable assets) of what to do with a tradeable asset (e.g., sell, buy, or hold). Such alerts may be customizable by users using “Alert Rules” or other settings, or may be provided as default alert settings set by the platform or an AI engine affiliated with the platform. Both a “Historical” tab 1620 and an “Upcoming” tab 1630 may also be provided to permit the user to view prior alerts as well as upcoming alerts, respectively, selectable for specified periods of time.

FIG. 16B illustrates a lower portion of the “Alerts” screens 1600 introduced above. In this scrolled-down portion of the Alerts screen 1600, additional alerts are displayed to a user. In the illustrated embodiment, an “Insider Trading Analysis” section 1640 displays information to the user pertaining to known or perceived “insider trading” events regarding certain tradeable assets. Another section 1650 of the screen 1600 displays information to the user pertaining to “candlestick” events regarding certain tradeable assets. FIG. 16C illustrates a further lower portion of the screen 1600 of FIGS. 16A and 16B. This lowest area of the screen 1600 includes an “Upgrades & Downgrades” section 1660, as well as a “Company alerts” section 1670, where both sections can provide relevant alerts and accompanying information to the user.

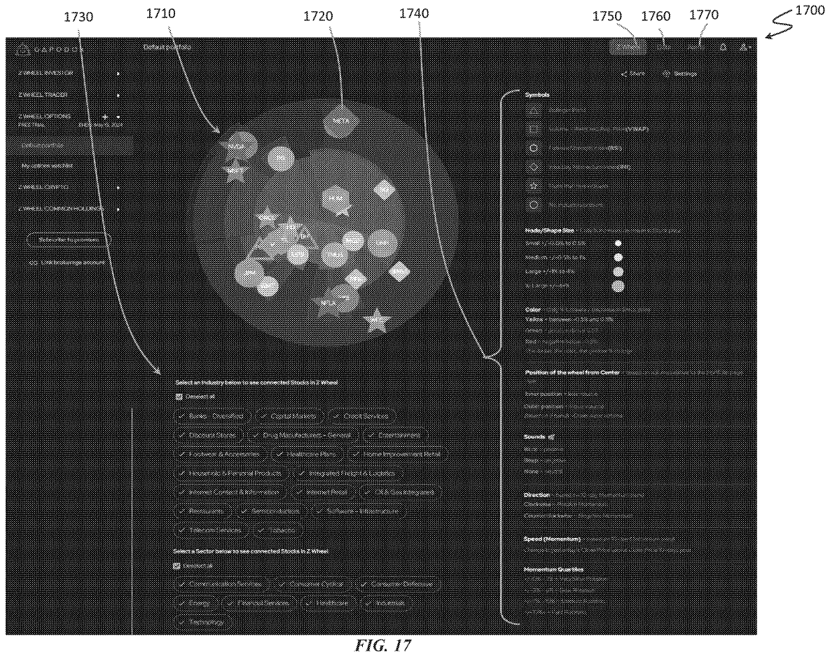

Turning now to FIG. 17, illustrated is a screenshot 1700 of another embodiment of a dynamic wheel interface 1710, where this wheel interface 1710 provides a dynamic visual representation tracking a plurality of assets comprising stock options. In this “Options” wheel interface 1710, the option assets being tracked may or may not be option assets held by the user viewing the interface 1710, but may instead be option assets selected by the user to dynamically track. Similar to the interfaces 900 and 1400 illustrated in FIGS. 9 and 14, respectively, this interface 1710 displays the plurality of option assets on a plurality of wedges within the wheel interface 1710. Each option asset is displayed as a node 1720 within a wedge and at a specific radial position on the wheel interface 1710. While a “default portfolio” is again displayed via the interface 1710, a subscribing user may make his own selections for display on the interface 1710 by clicking the “My options watchlist” option from the left-side menu.

The wheel interface 1710 also again incudes a plurality of wedges arranged within and revolving dynamically around the center of a common area. Each of the wedges corresponds to various option asset classes, and the shape, size, and movement of the wedges comprise characteristics based on data regarding each of the option asset classes. As before, the size of a wedge may correspond to a first characteristic indicative of a volume of the option assets within the asset class. In this illustrated embodiment, wedge size corresponds to the user's holding of the option assets within the class for that wedge. In contrast, wedges with smaller sizes correspond to the user holding a smaller amount of option assets within the class relative to his portfolio. Accordingly, a wedge significantly larger than another illustrated wedge indicates that the user holds significantly more option assets corresponding to the class in first wedge than those in second, smaller wedge. Selectable asset classes are provided in a clickable list 1730 underneath the displayed wheel interface 1710. From this list 1730, the user can select which class of assets to display on the wheel interface 1710, with such selection(s) being displayed in real-time on the interface 1710.

Another “Legend” 1740 is displayed along the right-side of the interface 1710, and which explains the meanings of the various symbols, colors, movements/velocities, and sizes/shapes of nodes displayed on the interface 1710. Again a Settings button is provided where the user is permitted to adjust various settings affecting the display of the interface 1710 as well as other parts of the screen 1700. A Share button is also again provided to permit the user to share his interface 1710 with other users, which can again be a general selection to make his interface 1710 publicly viewable or may be selected sharing with only certain other users. In either case, as described in detail above, the user may be rewarded for his sharing of his interface 1710, whether the reward is monetary or in the form of some other benefit provided to the user, such as reduced or waived subscriber fees to the platform. Monetization for the sharing of a user's interface 1710 may be in any one or more of the manners discussed above.

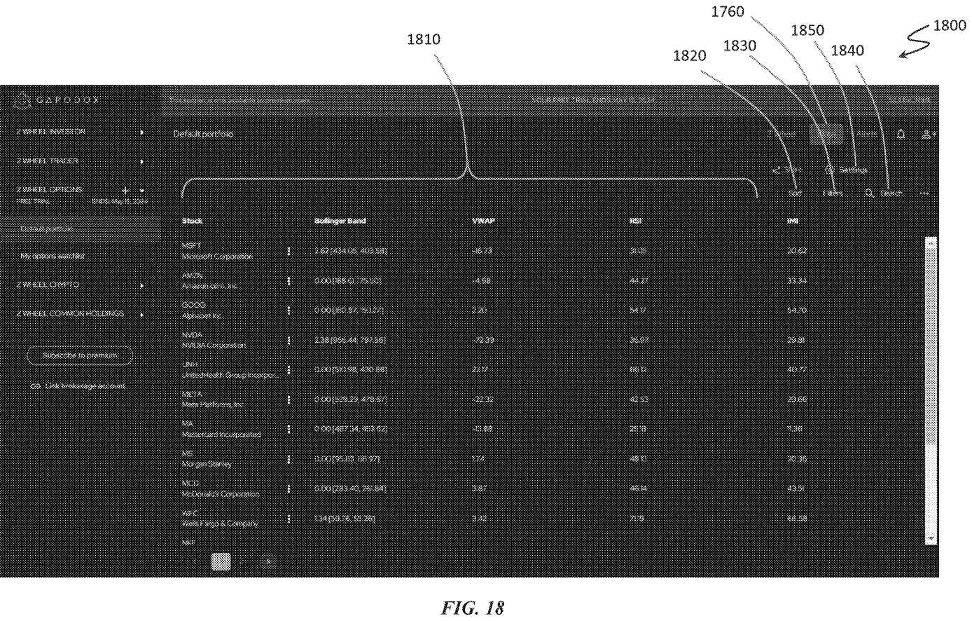

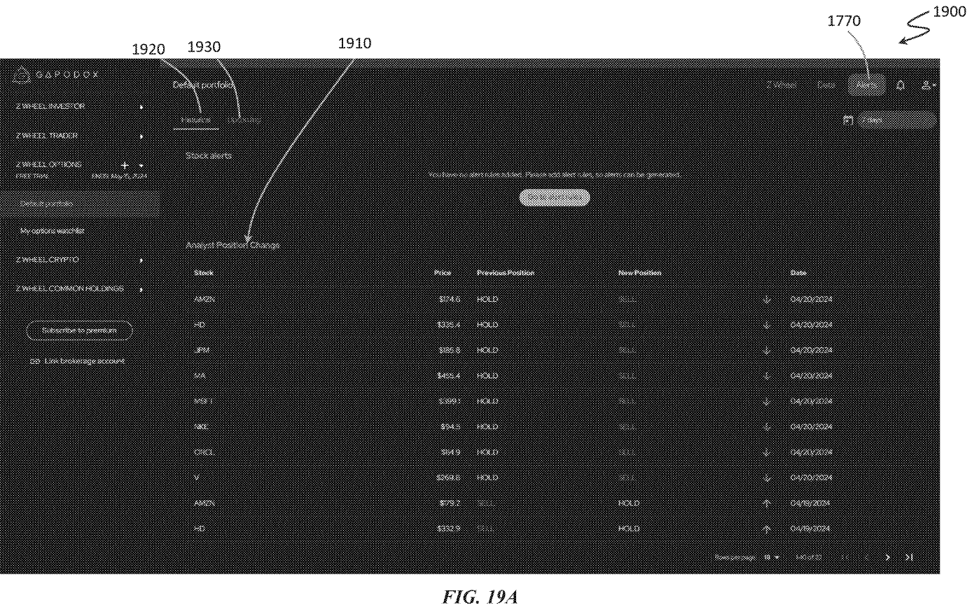

While the dynamic wheel interface 1710 is visually displayed on the screen 1700 when the “Z Wheel” button 1750 is selected, as with other wheel interfaces discussed above, the viewing user may again temporarily navigate away from the displayed interface 1710 by selecting the “Data” button 1760 or the “Alerts” button 1770, with similar information being respectively provided by each in substantially the same manner as described above. For example, FIG. 18 illustrates a screenshot 1800 displaying information regarding the option assets displayed on the wheel interface 1710 when the “Data” button 1760 is selected. The displayed data 1810 may again be organized in rows, where each row is dedicated to a particular tradeable asset, such as the stocks shown in the interface 1710. Columns may then be provided for each row to provide certain information, such as current price, change in price, volume of assets owned by the user, and momentum of the assets displayed on the wheel interface 1710, and any other information or data useful to users regarding the type of tradeable assets being presented. The presented data in the columns may again be sorted as desired with a “Sort” button 1820, as well as filtered by a “Filter” button 1830 as described above. Also, a user may search for a particular option asset using a “Search” field 1840. Once again selecting the “Settings” button 1850 can access various items the user may select or change in order to alter the data being displayed in the columns for each option asset.

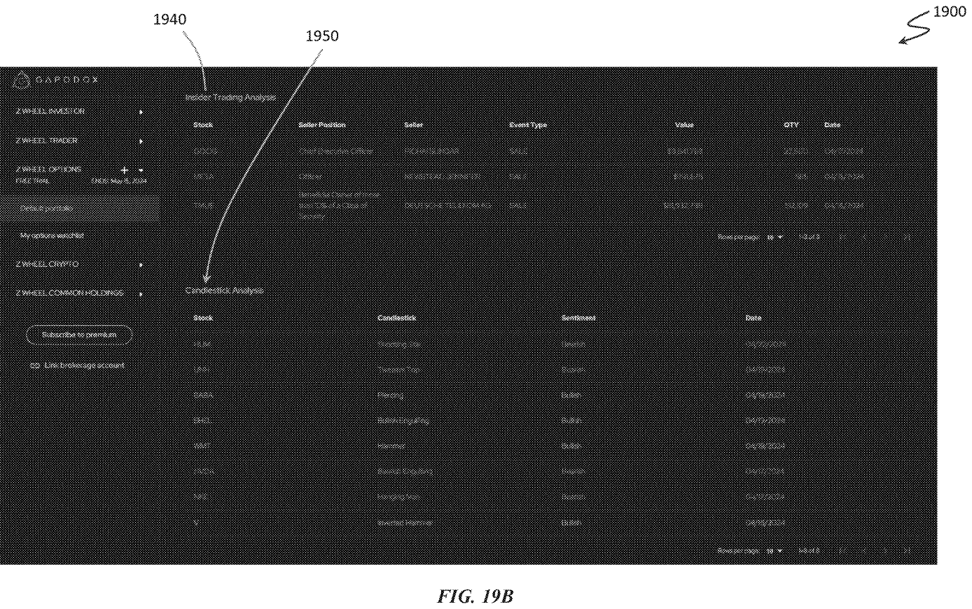

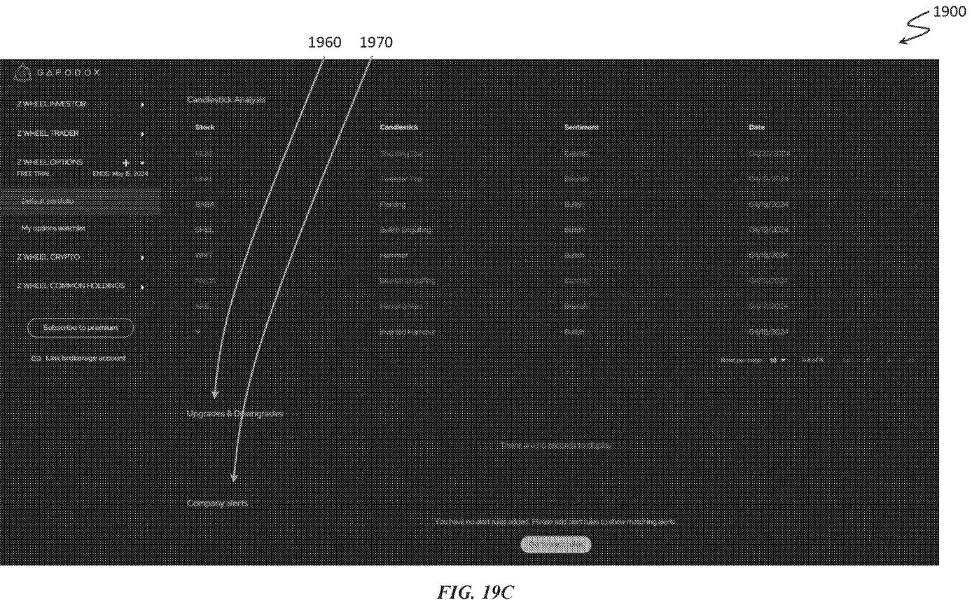

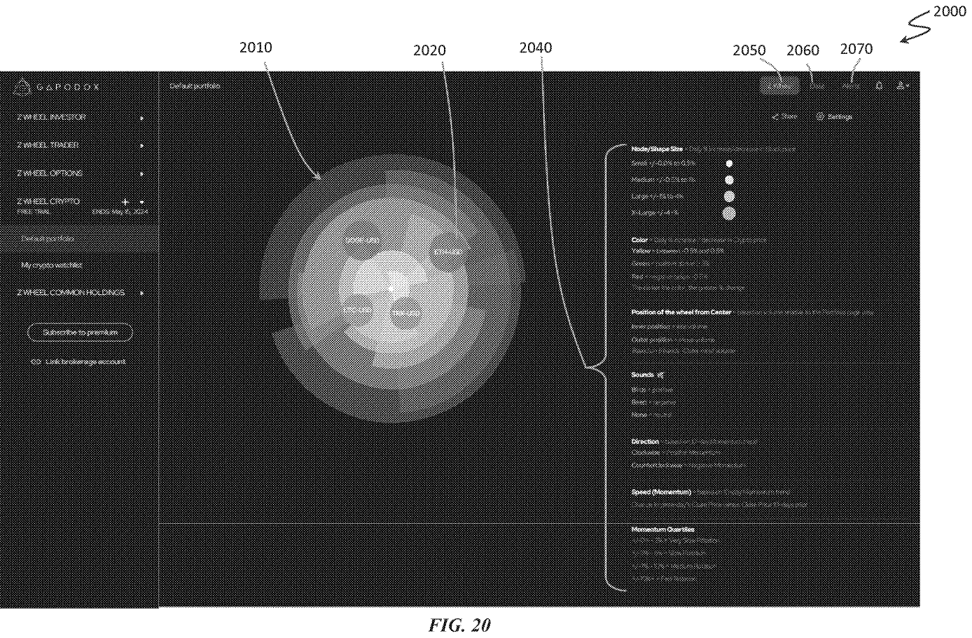

Looking now at FIG. 19A, illustrated is a screenshot 1900 displaying exemplary alerts to a user regarding the option assets displayed in the interface 1710 when the “Alerts” button 1770 is selected. As with the exemplary Alerts screens discussed above, a first portion of the alerts screen 1900, entitled “Analyst Position Change” 1910, provides information regarding the increased or decreased value of one or more option assets from the interface 1710, or perhaps suggestions by the platform (either via AI or tracking of other users'actions regarding the same or similar tradeable assets) of what to do with a tradeable asset (e.g., sell, buy, or hold). Such alerts may be customizable by users using “Alert Rules” or other settings, or may be provided as default alert settings set by the platform or an AI engine affiliated with the platform. Both a “Historical” tab 1920 and an “Upcoming” tab 1930 may also be provided to permit the user to view prior alerts as well as upcoming alerts, respectively, selectable for specified periods of time.

FIG. 19B illustrates a lower portion of the “Alerts” screens 1900 introduced above. In this scrolled-down portion of the Alerts screen 1900, additional alerts are displayed to a user. In the illustrated embodiment, an “Insider Trading Analysis” section 1940 displays information to the user pertaining to known or perceived “insider trading” events regarding certain tradeable assets. Another section 1950 of the screen 1900 displays information to the user pertaining to “candlestick” events regarding certain option assets. FIG. 19C illustrates a further lower portion of the screen 1900 of FIGS. 19A and 19B. This lowest area of the screen 1900 includes an “Upgrades & Downgrades” section 1960, as well as a “Company alerts” section 1970, where both sections can provide relevant alerts and accompanying information to the user.

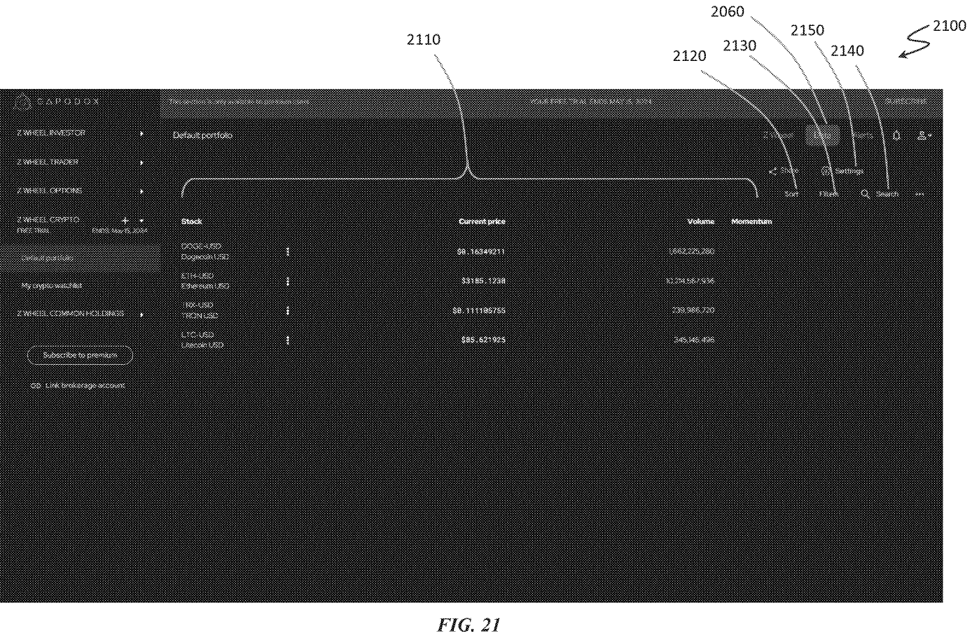

Turning now to FIG. 20, illustrated is a screenshot 2000 of another embodiment of a dynamic wheel interface 2010, where this wheel interface 2010 provides a dynamic visual representation tracking a plurality of tradeable assets, which in this case are cryptocurrencies. In this “Crypto” wheel 2010, the tradeable assets being tracked may or may not be tradeable assets held by the user viewing the interface 2010, but instead are assets selected by the user to dynamically track. Similar to the interface 900 illustrated in FIG. 9, this interface 2010 displays a plurality of tradeable assets illustrated on a plurality of wedges within the wheel interface 2010. Each tradeable asset is displayed as a node 2020 within a wedge and at a specific radial position on the wheel interface 2010. While a “default portfolio” is displayed via the interface 2010, a subscribing user may make his own selections for display on the interface 2010 by clicking the “My crypto watchlist” option from the left-side menu.

The wheel interface 2010 also again incudes a plurality of wedges arranged within and revolving dynamically around the center of a common area. Each of the wedges corresponds to various asset classes, and the shape, size, and movement of the wedges comprise characteristics based on data regarding each of the cryptocurrencies. As before, the size of a wedge may correspond to a first characteristic indicative of a volume of the cryptocurrencies within a particular class or characteristic. In this illustrated embodiment, wedge size corresponds to the user's holding of the cryptocurrencies for that wedge. In contrast, wedges with smaller sizes correspond to the user holding a smaller amount of cryptocurrencies relative to his portfolio. Accordingly, a wedge significantly larger than another illustrated wedge indicates that the user holds significantly more cryptocurrencies corresponding to the cryptocurrencies in first wedge than those in second, smaller wedge. While just certain cryptocurrencies are shown displayed on the interface 2010, a list of all available cryptocurrencies may also be provided to a user from which he would select the cryptocurrencies to be displayed on the interface 2010.

Another “Legend” 2040 is displayed along the right-side of the interface 2010, and which explains the meanings of the various symbols, colors, movements/velocities, and sizes/shapes of nodes 2020 displayed on the interface 2010. Again a Settings button is provided where the user is permitted to adjust various settings affecting the display of the interface 2010 as well as other parts of the screen 2000. A Share button is also again provided to permit the user to share his interface 2010 with other users, which can again be a general selection to make his interface 2010 publicly viewable or may be selected sharing with only certain other users. In either case, as described in detail above, the user may be rewarded for his sharing of his interface 2010, whether the reward is monetary or in the form of some other benefit provided to the user, such as reduced or waived subscriber fees to the platform. Monetization for the sharing/socialization of a user's interface 1710 may be in any one or more of the manners discussed above.

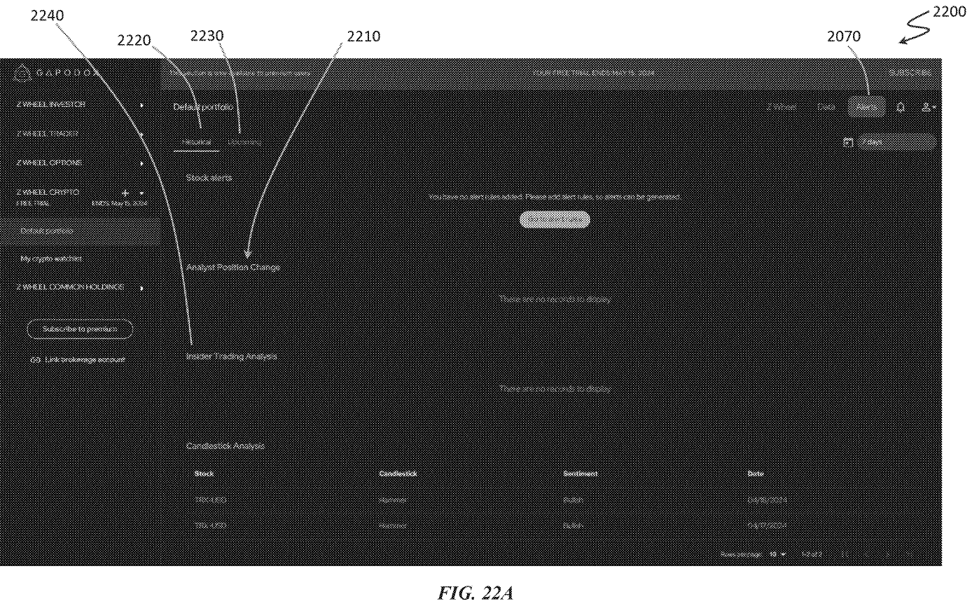

While the dynamic wheel interface 2010 is visually displayed on the screen 2000 when the “Z Wheel” button 2050 is selected, the viewing user may again temporarily navigate away from the displayed interface 2010 by selecting the “Data” button 2060 or the “Alerts” button 2070, with similar information being respectively provided by each in substantially the same manner as described above. For example, FIG. 21 illustrates a screenshot 2100 displaying information to a user when the “Data” button 2060 is selected. The displayed data 2110 may again be organized in rows, where each row is dedicated to a particular tradeable asset, such as the “stocks” (i.e., asset in this case) shown in the interface 2010. Columns may then be provided for each row to provide certain information, such as current price, change in price, volume of assets owned by the user, and momentum of the assets displayed on the wheel interface 2010, and any other information or data useful to users regarding the type of tradeable assets being presented. The presented data in the columns may again be sorted as desired with a “Sort” button 2120, as well as filtered by a “Filter” button 2130 as described above. Also, a user may search for a particular tradeable asset using a “Search” field 2140. Once again selecting the “Settings” button 2150 can access various items the user may select or change in order to alter the data being displayed in the columns for each tradeable asset.

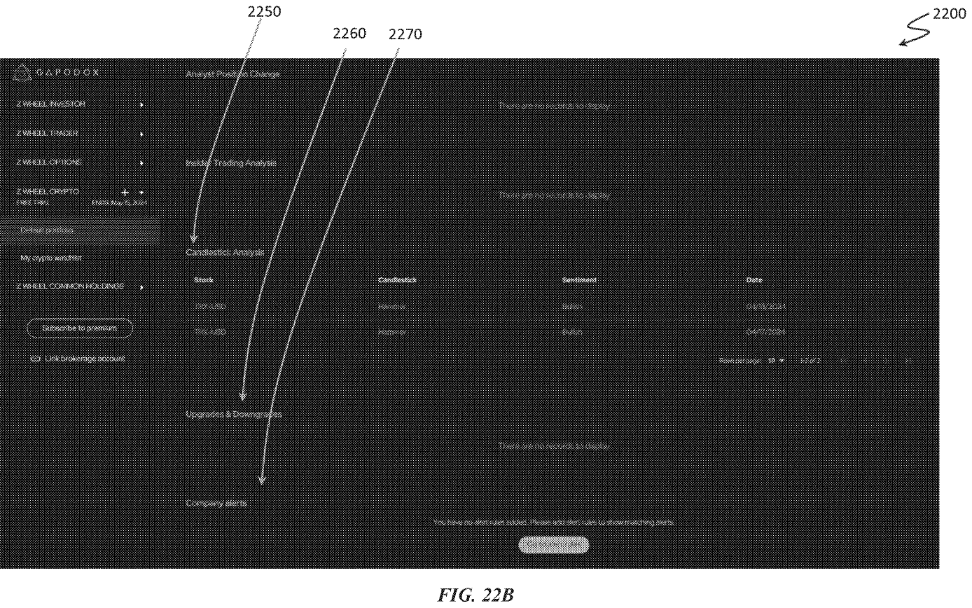

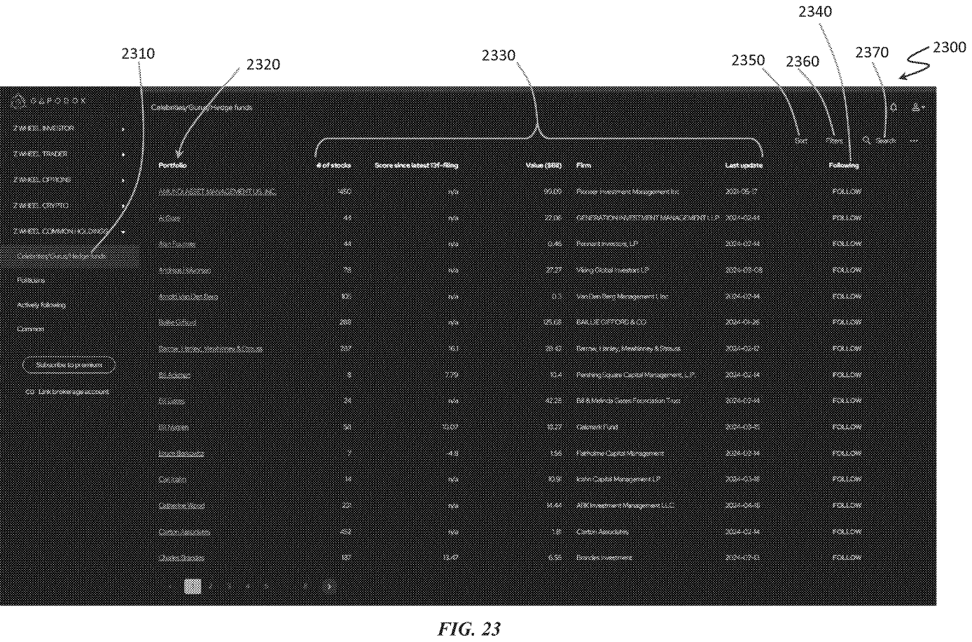

Looking now at FIG. 22A, illustrated is a screenshot 2200 displaying exemplary alerts to a user regarding the cryptocurrency assets displayed in the interface 2010 when the “Alerts” button 2070 is selected. As with the exemplary Alerts screen discussed above, a first portion of the alerts screen 2200, entitled “Analyst Position Change” 2210, provides information regarding the increased or decreased value of one or more tradeable assets from the interface 2010, or perhaps suggestions by the platform (either via AI or tracking of other users'actions regarding the same or similar tradeable assets) of what to do with a tradeable asset (e.g., sell, buy, or hold). Such alerts may be customizable by users using “Alert Rules” or other settings, or may be provided as default alert settings set by the platform or an AI engine affiliated with the platform. Both a “Historical” tab 2220 and an “Upcoming” tab 2230 may also be provided to permit the user to view prior alerts as well as upcoming alerts, respectively, selectable for specified periods of time.

FIG. 22B illustrates a lower portion of the “Alerts” screens 2200 introduced above. In this scrolled-down portion of the Alerts screen 2200, additional alerts are displayed to a user. In the illustrated embodiment, an “Insider Trading Analysis” section 2240 displays information to the user pertaining to known or perceived “insider trading” events regarding certain tradeable assets. Another section 2250 of the screen 2200 displays information to the user pertaining to “candlestick” events regarding certain tradeable assets. FIG. 22B further illustrates an “Upgrades & Downgrades” section 2260, as well as a “Company alerts” section 2270, where both sections can provide relevant alerts and accompanying information to the user.

Turning now to FIG. 23, illustrated is a screenshot 2300 of a list of certain portfolios that are known through the platform. In this embodiment, the portfolio list selected by the user to display on the screen 2300 is selected from the left-side menu as “Celebrities/Gurus/Hedge funds” 2310. This selection displays a list of portfolios 2320 actually held by certain celebrities, “guru” investors and hedge funds affiliated or otherwise known to the platform, and which in this illustrated embodiment is presented alphabetically to the user.

For each investor/trader/fund displayed in the list 2320, a plurality of data/information 2330 regarding the tradeable assets held by each party/entity in the list 2320 is displayed to the user. This data 2330 may include value and volume of tradeable assets held, what firm the investor/trader/fund has their tradeable assets affiliated with, and the date for the data provided. Additionally, an option to “follow” 2340 any of the investor/trader/fund on the displayed list 2320 is also provided to the user, where the user may simply click the “follow” link to do so. Following a portfolio not only provides important data regarding the portfolio, such as that displayed on the screen 2300, but also permits a user to display the portfolio via one or more of the wheel interfaces disclosed herein.

As with other data presentations disclosed herein, the displayed data 2330 may again be organized in rows, where each row is dedicated to a portfolio of a particular investor/trader/fund. Columns then provide for each row certain information that may be adjusted via a Settings option by the user. The presented data 2330 in the columns may again be sorted as desired with a “Sort” button 2350, as well as filtered by a “Filter” button 2360 as described above. Also, a user may search for a particular tradeable asset using a “Search” field 2370. Selecting a “Settings” button (not illustrated), which may be accessible via the ellipses ( . . . ) symbol, and can access various items the user may select or change in order to alter the data 2330 being displayed in the columns for each portfolio.

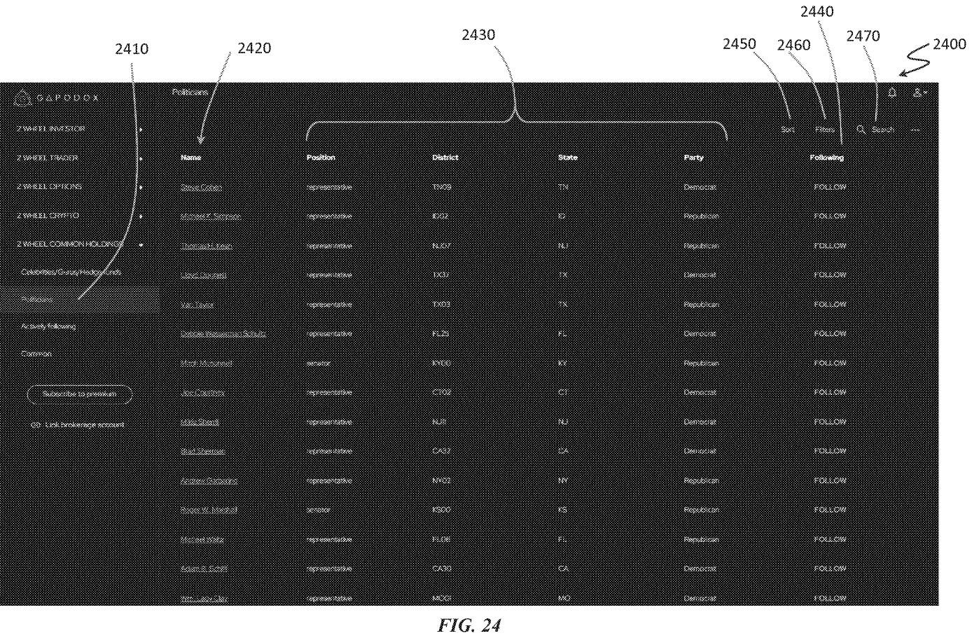

Looking now to FIG. 24, illustrated is a screenshot 2400 of a different list of portfolios that are accessible through the platform. In this embodiment, the portfolio list selected by the user to display on the screen 2400 is selected from the left-side menu as “Politicians” 2410. This selection displays a list of portfolios 2420 actually held by certain politicians affiliated or otherwise known to the platform.

For each politician displayed in the list 2420, a plurality of data/information 2430 regarding the politicians themselves is displayed to the user. The displayed data 2430 may include each politician's position, district and state they represent, and their party affiliation. Alternatively, data regarding the tradeable assets held by each politician in the list 2420 may be displayed to the user via a selection to do so. Additionally, an option to “follow” 2440 any of the politicians on the displayed list 2420 is also provided to the user, where the user may simply click the “follow” link to do so. Following a portfolio not only provides important data regarding the portfolio, such as that displayed on the screen 2400, but also permits a user to display the portfolio via one or more of the wheel interfaces disclosed herein.

As with other data presentations disclosed herein, the displayed data 2430 may again be organized in rows, where each row is dedicated to a portfolio of a particular politician. Columns then provide for each row certain information that may be adjusted via a Settings option by the user. The presented data 2430 in the columns may again be sorted as desired with a “Sort” button 2450, as well as filtered by a “Filter” button 2460 as described above. Also, a user may search for a particular politician using a “Search” field 2470. Selecting a “Settings” button (not illustrated) but which may be accessible via the ellipses ( . . . ) symbol can access various items the user may select or change in order to alter the data 2430 being displayed in the columns for each portfolio.

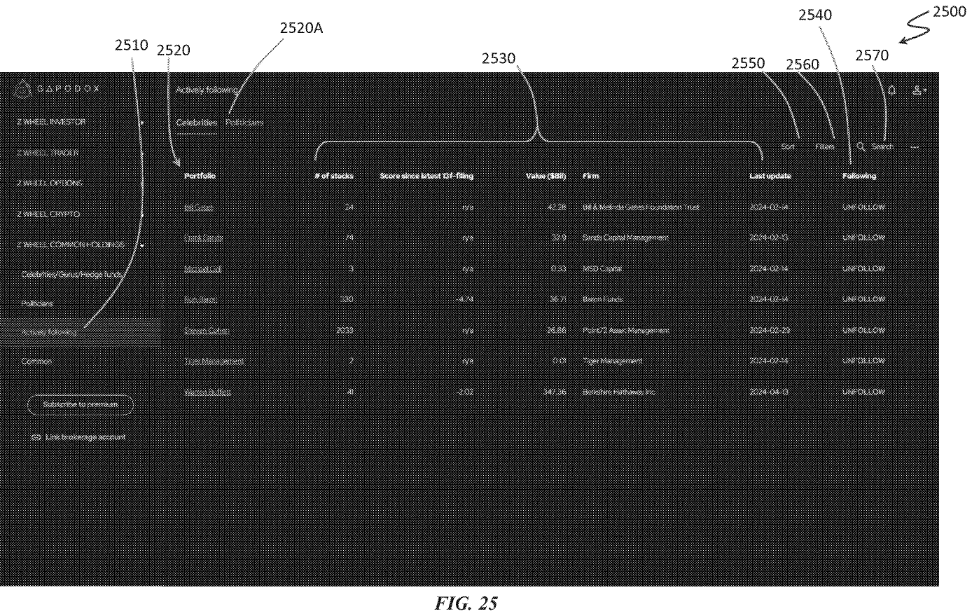

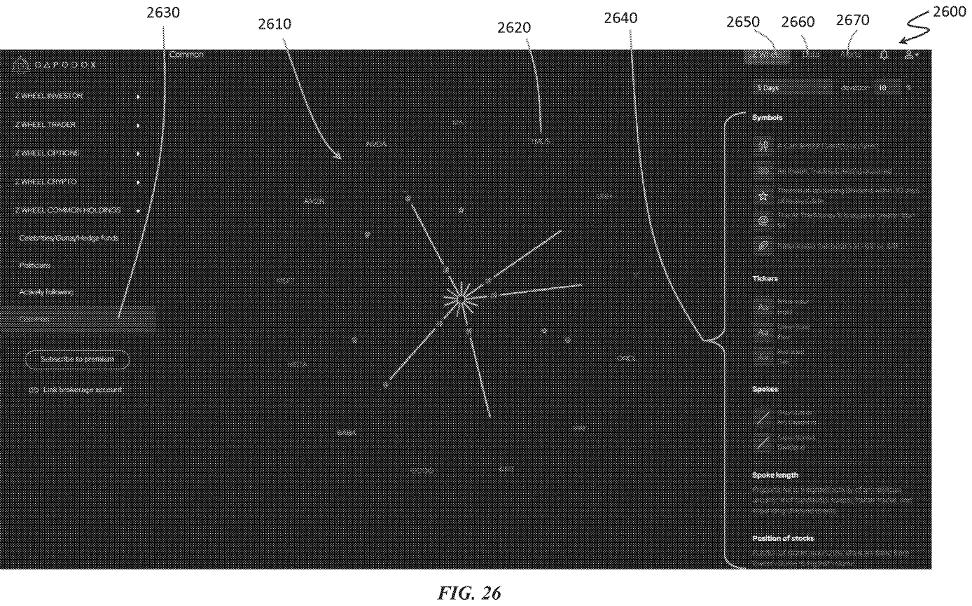

Referring now to FIG. 25, illustrated is a screenshot 2500 of a list of portfolios that are being “followed” by a user of the platform. In this embodiment, the displayed list of followed portfolios is selected by the user from the left-side menu as “Actively followed” 2510. This selection displays a list of portfolios 2520 the user has previously selected to follow using the platform. Following a portfolio not only provides important data regarding the portfolio, such as that displayed on the screen 2500, but also permits a user to display the portfolio via one or more of the wheel interfaces disclosed herein.

For each followed portfolio displayed in the list 2520, a plurality of data/information 2530 regarding the followed portfolio is displayed to the user. The displayed data 2530 may include value and volume of tradeable assets held, what firm the investor/trader/fund has their tradeable assets affiliated with, and the date for the data provided. Alternatively, data regarding the investor/trader/fund being followed may be displayed to the user via a selection to do so. Additionally, an option to “unfollow” 2540 any of the followed portfolio is also provided to the user, where the user may simply click the “unfollow” link to do so.

As with other data presentations disclosed herein, the displayed data 2530 may again be organized in rows, where each row is dedicated to a portfolio of a particular followed portfolio. Columns then provide for each row certain information that may be adjusted via a Settings option by the user. The presented data 2530 in the columns may again be sorted as desired with a “Sort” button 2550, as well as filtered by a “Filter” button 2560 as described above. Also, a user may search for a particular politician using a “Search” field 2570. Selecting a “Settings” button (not illustrated) but which may be accessible via the ellipses ( . . . ) symbol can access various items the user may select or change in order to alter the data 2530 being displayed in the columns for each followed portfolio.

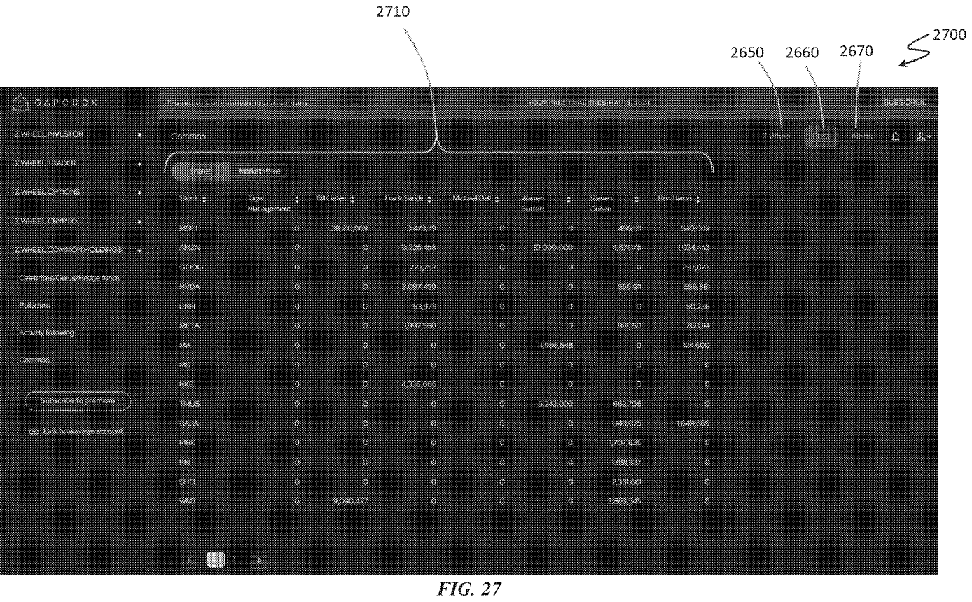

Turning now to FIG. 26, illustrated is a screenshot 2600 of another embodiment of a dynamic wheel interface 2610, where this wheel interface 2610 provides a dynamic visual representation tracking a plurality of tradeable assets commonly held in portfolios being “followed” by the viewing user. In this example, the commonly held tradable assets are illustrated as labels 2620 organized around the circumference of the interface 2610. As such, this wheel interface 2610 is accessed by clicking the appropriate “Common” button 2630 in the selectable menu 2630 on the left side of the display screen 2600.

As with the interface embodiment shown in FIGS. 5 and 10, the interface 2610 in FIG. 26 displays the plurality of commonly tradable assets (shown by their ticker symbol) are arranged around the periphery of a plurality of concentrically-aligned annular regions. As with the other similar embodiments disclosed herein, information pertaining to each commonly held asset is designated by placement of one or more graphical elements in these annular regions, extending in a radial direction from an origin at the center of the wheel interface 2610 outwards towards the respective commonly held assets. Also as before, placement of the ticker symbols may be indicative of the volume of the commonly held tradeable assets corresponding to the ticker symbols. In one embodiment, the placement of the ticker symbols is indicative on increasing volume, with volume increasing in a clockwise direction. In another embodiment, the placement of the ticker symbols is indicative on increasing volume, with volume increasing in a counterclockwise direction.

Also as before, the interface 2610 again includes lines extending from the origin toward each ticker symbol representing the commonly held assets. These lines can be dividend symbols that include at least: (i) a first variable aspect, and (ii) a second variable aspect. An example of the first variable aspect can be an appearance of the line (such a different colors) that graphically indicates whether or not a dividend is paid to holders of the commonly held asset. Similar to the interface 1100 of FIG. 10, line colors are used to provide such information. The second variable aspect of the lines can graphically indicate a relative quantity of events that occurred, or are scheduled to occur involving the commonly held tradeable assets displayed on the interface 2610. For example, the longer the line, the greater the number of events that have occurred, or are scheduled to occur involving the tradeable assets. However, other graphical aspects of the line such as a color code, a size, a shape, or any other graphical element can be utilized as the first variable aspect.

According to some embodiments, examples of the events include, but are not limited to: candlestick events, insider trades, impending dividend events, any other event, and any combination thereof. In this exemplary screen 2600, a Legend 2640 is again provided along the right side of the display screen 2600 to explain to a user what certain symbols mean for a particular commonly held asset. As described above, such symbols can be arranged within the annular regions in the radial direction extending from the origin to the respective ticker symbol. For example, a marker such as the “at” symbol (@) can be placed in an annular region, which can be designated for markers that identify commonly held assets for which the “at the money” percentage exceeds a percentage specified in the configuration package, which may be user-defined. In the illustrative embodiment of FIG. 26, the defined tolerance was again specified as five (5%) in the configuration package. Similarly, another or the same annular region can be designated to display markers such as a star (★), which is indicative of an upcoming dividend payment within a predefined period (perhaps by the user as well) from the date on which the numeric and transaction data is received by the aggregation module 112 described above. In the example of FIG. 26, the stars (★) indicate that two commonly held assets have an upcoming dividend payment within the next thirty (30) days.

A display marker that is an eye may again also be used in one or more of the annular regions to indicate that an insider trading event has occurred. Also as before, a display marker that is a candlestick marker may also be displayed in an annular region to indicate a candlestick event has occurred. Any one or more of the visual indicators described above for other embodiments of a wheel interface in accordance with the disclosed principles may also be included on the wheel interface 2610 of FIG. 26.

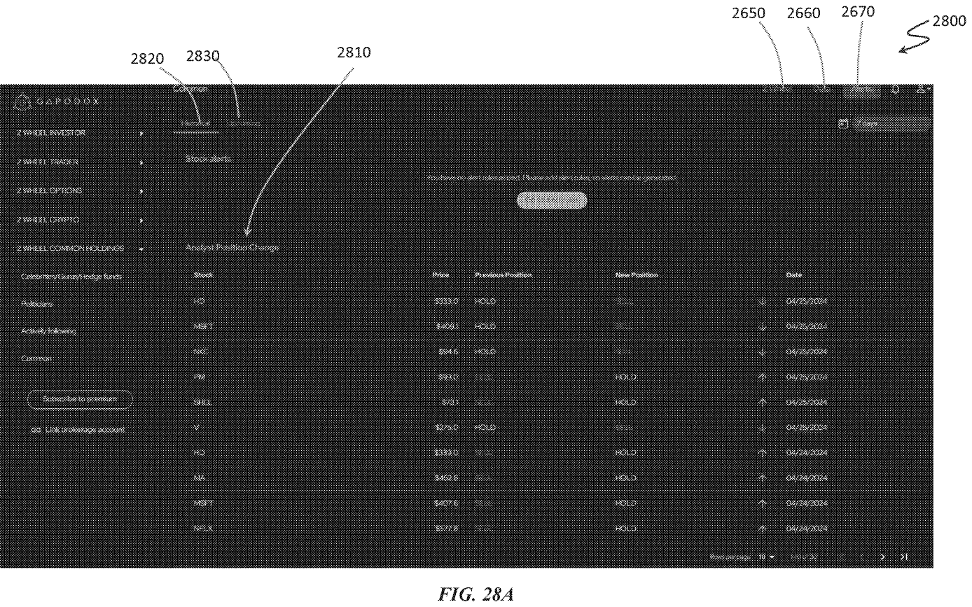

While presentation of the wheel interface 2610 of commonly held assets is provided to a user when selecting the “Z Wheel” button 2650, the viewing user may again temporarily navigate away from the displayed interface 2610 by selecting the “Data” button 2660 or the “Alerts” button 2670, with similar information being respectively provided by each in substantially the same manner as described above. For example, FIG. 27 illustrates a screenshot 2700 displaying information regarding the commonly held assets displayed on the wheel interface 2610 when the “Data” button 2660 is selected. The displayed data 2710 may again be organized in rows, where each row is dedicated to a particular tradeable asset, such as the commonly held stocks shown in the interface 2610. Columns may then be provided for each row to provide certain information, which in this example is the name of the investor/trader/fund that holds shares of the commonly held stocks, and how much. The presented data in the columns may be altered from a display by a “Shares” button of the commonly held assets to a “Market Value” button that displays in the columns of holders of each commonly held stock the market value of their respectively held assets, rather than the number of shares.

While not illustrated, the displayed data 2710 may optionally be sorted as desired with a “Sort” button as well as filtered by a “Filter” button as described above. Also, a user may search for a particular option asset using a “Search” field (not illustrated), as also described above. Once again, a “Settings” button (not illustrated) as also described can access various items the user may select or change in order to alter the data 2710 being displayed in the columns and/or rows for each commonly held assets displayed.

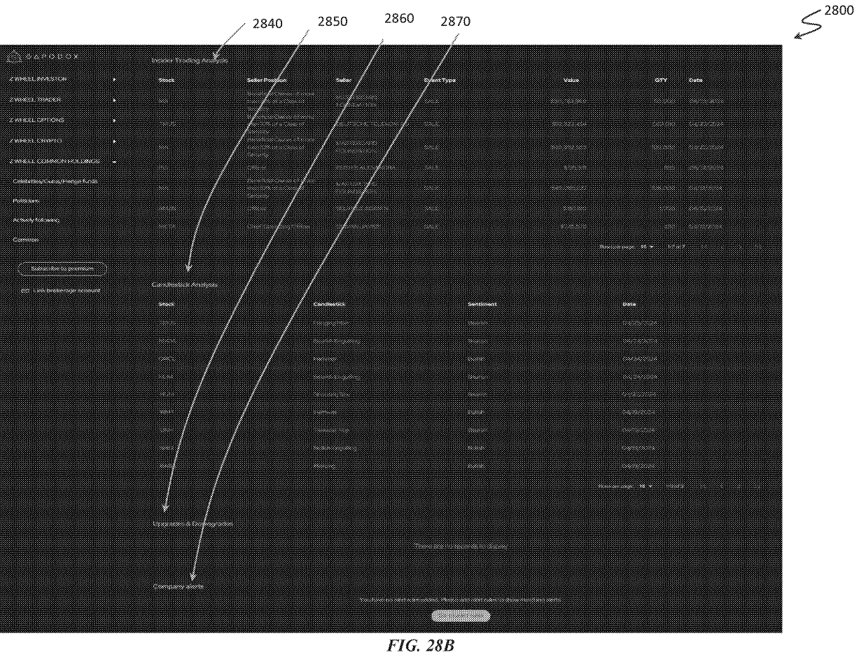

Looking now at FIG. 28A, illustrated is a screenshot 2800 displaying exemplary alerts to a user regarding the option assets displayed in the interface 2610 when the “Alerts” button 2670 is selected. As with the exemplary Alerts screens discussed above, a first portion of the alerts screen 2800, entitled “Analyst Position Change” 2810, provides information regarding the increased or decreased value of one or more option assets from the interface 2610, or perhaps suggestions by the platform (either via AI or tracking of other users'actions regarding the same or similar tradeable assets) of what to do with a tradeable asset (e.g., sell, buy, or hold). Such alerts may be customizable by users using “Alert Rules” or other settings, or may be provided as default alert settings set by the platform or an AI engine affiliated with the platform. Both a “Historical” tab 2820 and an “Upcoming” tab 2830 may also be provided to permit the user to view prior alerts as well as upcoming alerts, respectively, selectable for specified periods of time.

FIG. 28B illustrates a lower portion of the “Alerts” screens 2800 introduced above. In this scrolled-down portion of the Alerts screen 2800, additional alerts are displayed to a user. In the illustrated embodiment, an “Insider Trading Analysis” section 2840 displays information to the user pertaining to known or perceived “insider trading” events regarding certain commonly owned tradeable assets. Another section 2850 of the screen 2800 displays information to the user pertaining to “candlestick” events regarding certain option assets. In the lowest area of the screen 2800 includes an “Upgrades & Downgrades” section 2860, as well as a “Company alerts” section 2870, where both sections can provide relevant alerts and accompanying information to the user in the same manner as other embodiments discussed above.

### Exemplary Computing Device/System

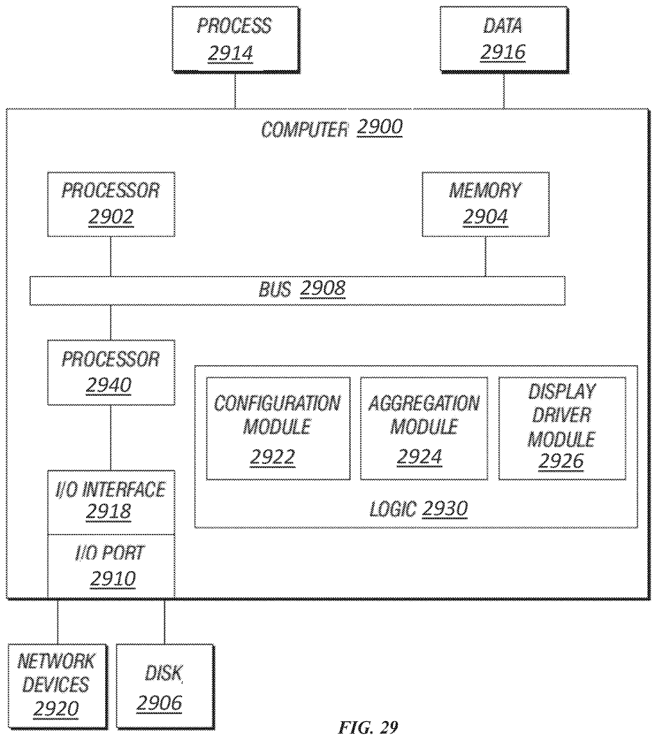

Looking back to FIG. 29, illustrate is an example of a computing device that is configured and/or programmed with one or more of the example systems and methods described herein, and/or equivalents. The exemplary computing device may be a computer 2900 that includes a processor 2902, a memory 2904, and input/output ports 2910 operably connected by a bus 2908. In one example, the computer 2900 may include logic 2930 configured to control operation of a display 102 with respect to the system 100 shown in FIG. 1. In different examples, the logic 2930 may be implemented in hardware, a non-transitory computer-readable medium with stored instructions, firmware, and/or combinations thereof. While the logic 2930 is illustrated as a hardware component attached to the bus 2908, it is to be appreciated that in other embodiments, the logic 2930 could be implemented in the processor 2902, stored in memory 2904, or stored in disk 2906.

In one embodiment, logic 2930 or the computer 2900 is a means (e.g., structure: hardware, non-transitory computer-readable medium, firmware) for performing the actions described. In some embodiments, the computer 2900 may be a server operating in a cloud computing system, a server configured in a Software as a Service (SaaS) architecture, a smartphone, laptop, tablet computing device, and so on.

The means may be implemented, for example, as an ASIC programmed to authorize communications between members, and limit communications to authorized members. The means may also be implemented as stored computer executable instructions that are presented to computer 2900 as data 2916 that are temporarily stored in memory 2904 and then executed by processor 2902.

The logic 2930 may also provide means (e.g., hardware, non-transitory computer-readable medium that stores executable instructions, firmware) for performing the operations regarding controlling the display 102, via a display driver module 2026, as described herein.

Generally describing an illustrative configuration of the computer 2900, the processor 2902 may be a variety of various processors including dual microprocessor and other multi-processor architectures. The memory 2904 may include volatile memory and/or non-volatile memory. Non-volatile memory may include, for example, ROM, PROM, and so on. Volatile memory may include, for example, RAM, SRAM, DRAM, and so on.

The storage 2906 may be operably connected to the computer 2900 via, for example, an input/output (I/O) interface (e.g., card, device) 2918 and an input/output port 2910. The storage 2906 may be, for example, a magnetic disk drive, a solid-state disk drive, a floppy disk drive, a tape drive, a Zip drive, a flash memory card, a memory stick, and so on. Furthermore, the storage 2906 may be a CD-ROM drive, a CD-R drive, a CD-RW drive, a DVD-ROM, and so on. The memory 2904 can store a process 2924 and/or a data 2916, for example. The disk 2906 and/or the memory 2904 can store an operating system that controls and allocates resources of the computer 2900.

The computer 2900 may interact with input/output (I/O) devices via the I/O interfaces 2918 and the input/output ports 2910. Input/output devices may be, for example, a keyboard, a microphone, a pointing and selection device, cameras, video cards, displays, the disk 2906, the network devices 2920, and so on. The input/output ports 2910 may include, for example, serial ports, parallel ports, and USB ports.

The computer 2900 can operate in a network environment and thus may be connected to the network devices 2920 via the I/O interfaces 2918, and/or the I/O ports 2910. Through the network devices 2920, the computer 2900 may interact with a network. Through the network, the computer 2900 may be logically connected to remote computers. Networks with which the computer 2900 may interact include, but are not limited to, a LAN, a WAN, and other networks.

In one or more embodiments, the disclosed methods or their equivalents are performed by either: computer hardware configured to perform the method; or computer instructions embodied in a module stored in a non-transitory computer-readable medium where the instructions are configured as an executable algorithm configured to perform the method when executed by at least a processor of a computing device.

While for purposes of simplicity of explanation, the illustrated methodologies in the figures are shown and described as a series of blocks of an algorithm, it is to be appreciated that the methodologies are not limited by the order of the blocks. Some blocks can occur in different orders and/or concurrently with other blocks from that shown and described. Moreover, less than all the illustrated blocks may be used to implement an example methodology. Blocks may be combined or separated into multiple actions/components. Furthermore, additional and/or alternative methodologies can employ additional actions that are not illustrated in blocks.

### Exemplary Artificial Intelligence Implementations

Advantageously, most or all of the functionality of systems, methods, and platforms described discussed above may be implemented or assisted by the use of artificial intelligence (AI). Those skilled in the pertinent fields of art are knowledgeable about the development and use of artificial intelligence, and thus a detailed discussion of these will not be included here. However, the AI principles for providing suggestions to manage a portfolio disclosed in U.S. Pat. No. 11,443,380 may be utilized and is incorporated by reference. Additionally, the implementation of AI into some or all of the unique functionality of systems, methods, and platforms designed or constructed in accordance with the disclosed principles results in novel applications and results. AI may not only do a better job of including all relevant information about the user's trading preferences that the user may forget to employ in the portfolio but may also better present that information. Such better presentation may also be tailored to the user's purpose for using the systems, methods, and platforms, such as tailoring the portfolio for the best presentation to trade assets.

For example, as mentioned above, the AI may suggest trading recommendations based on, for example, the user's trading tendencies. For example, the AI may provide buy or sell recommendations for the user's tradeable assets based on the user's historical actions for candlestick events, insider trading events, upcoming dividends (or no dividends), at the money, and/or natural ratio occurrence. The AI may provide buy or sell recommendations for the user's tradeable assets based on the user's historical actions with the same asset or similar assets. Additionally, the AI may ask the user questions about the portfolio to optimize the holdings. For example, the AI may learn that the user has a preference for assets within a certain class or sector (e.g., energy, finance, healthcare, telecommunications, etc.) and provides recommendations for assets within that class or sector. Further, the AI may learn that the user has a preference for characteristics (e.g., pays dividends, short selling, etc.) of these assets and provides recommendations for assets within that class or sector that match the user's preferred characteristics.

Additionally, the AI may suggest trading recommendations based on, for example, the user's trading tendencies. For example, the AI may provide buy or sell recommendations for the user's tradeable assets based on the user's historical threshold values of performance indicators. Additionally, the AI may provide buy or sell recommendations for the user's tradeable assets based on the user's historical actions with the same asset or similar assets. For example, the AI will understand when the user prefers to buy or sell at certain trading momentum speed, momentum direction, percent change in price, etc. Additionally, the AI may ask the user questions about the portfolio to optimize the holdings. For example, the AI may learn that the user has a preference for assets within a certain class or sector (e.g., energy, finance, healthcare, telecommunications, etc.) and provides recommendations for assets within that class or sector. Further, the AI may learn that the user has a preference for characteristics (e.g., pays dividends, short selling, momentum tendencies, etc.) of these assets and provides recommendations for assets within that class or sector that match the user's preferred characteristics. Additionally, in any and all of the described situations, a user may ask the AI questions about their portfolio to obtain information or recommendations. For example, the user may ask the AI for suggestions on investment strategy, how to manage the portfolio, buy/sell actions, or portfolios of other users that have better returns.

In yet another aspect, the AI may suggest portfolios of other users for the user to follow, based on the user's holdings and trading tendencies. For example, the AI may identify portfolios of other users with similar volume but higher returns. Additionally, the AI may identify portfolios of other users with similar trading tendencies but higher returns. The AI may suggest that the user follow these portfolios to help improve the user's returns. The AI may also suggest investment actions for the user to take based on the suggested portfolios. For example, the AI may suggest that the user trade out of a certain asset and buy a similar that is held a followed user and producing better returns.

Other potential implementations of AI for users are the use of AI to help customize the interface 500 and/or the dynamic interface 900, or any interface in accordance with the disclosed principles. For example, the user may interact with the AI to answer questions concerning preference about information presented in the interface 500 and/or the dynamic interface 900, or any interface in accordance with the disclosed principles. The user may learn how any such interface operates and why they should have certain information presented. Based on the user's answers, the AI will provide suggestions on which information should be presented in an interface, and the AI may generally provide the user with educational information on finance as well as how the educational information may be visualized on an interface. Additionally, the AI may periodically follow-up with the user about the information preferences, as the preferences may change over time and based on the user's trading tendencies evolving.

The following sections'content includes definitions of selected terms employed herein. These definitions include various examples and/or forms of components that fall within the scope of a term and that may be used for implementation. These examples are not intended to be limiting. Both singular and plural forms of terms may be included within these definitions.

References to “one embodiment,” “an embodiment,” “one example,” “an example,” and so on, indicate that the embodiment(s) or example(s) so described may include a particular feature, structure, characteristic, property, element, or limitation, but that not every embodiment or example necessarily includes that particular feature, structure, characteristic, property, element or limitation. Furthermore, repeated use of the phrase “in one embodiment” does not necessarily refer to the same embodiment, though it may.

A “data structure,” as used herein, is an organization of data in a computing system that is stored in a memory medium, a storage device, or other computerized system. A data structure may be any one of, for example, a data field, a data file, a data array, a data record, a database, a data table, a graph, a tree, a linked list, and so on. A data structure may be formed from and contain many other data structures (e.g., a database includes many data records). Other examples of data structures are possible as well, in accordance with other embodiments.

“Computer-readable medium” or “computer storage medium,” as used herein, refers to a non-transitory medium that stores instructions and/or data configured to perform one or more of the disclosed functions when executed by at least a single processor. Data may function as instructions in some embodiments. A computer-readable medium may take forms, including, but not limited to, non-volatile media or volatile media. Non-volatile media may include, for example, optical disks, magnetic disks, and so on. Volatile media may include, for example, semiconductor memories, dynamic memory, and so on. Common forms of a computer-readable medium may include, but are not limited to, a floppy disk, a flexible disk, a hard disk, a magnetic tape, other magnetic medium, an application specific integrated circuit (ASIC), a programmable logic device, a compact disk (CD), other optical medium, a random access memory (RAM), a read-only memory (ROM), a memory chip or card, a memory stick, solid-state storage device (SSD), flash drive, and other media from which a computer, a processor or other electronic device can function with. Each type of media, if selected for implementation in one embodiment, may include stored instructions of an algorithm configured to perform one or more of the disclosed and/or claimed functions.

“Logic,” as used herein, represents a component that is implemented with computer or electrical hardware, a non-transitory medium with stored instructions of an executable application or program module, and/or combinations of these to perform any of the functions or actions as disclosed herein, and/or to cause a function or action from another logic, method, and/or system to be performed as disclosed herein. Equivalent logic may include firmware, a microprocessor programmed with an algorithm, a discrete logic (e.g., ASIC), at least one circuit, an analog circuit, a digital circuit, a programmed logic device, a memory device containing instructions of an algorithm, and so on, any of which may be configured to perform one or more of the disclosed functions. In one embodiment, logic may include one or more gates, combinations of gates, or other circuit components configured to perform one or more of the disclosed functions. Where multiple logics are described, it may be possible to incorporate the multiple logics into one logic. Similarly, where a single logic is described, it may be possible to distribute that single logic between multiple logics. In one embodiment, one or more of these logics are corresponding structure associated with performing the disclosed and/or claimed functions. Choice of which type of logic to implement may be based on desired system conditions or specifications. For example, if greater speed is a goal, then hardware would be selected to implement functions. If a lower cost is desired, then stored instructions/executable application would be selected to implement the functions.

While the disclosed embodiments have been illustrated and described in considerable detail, it is not the intention to restrict or in any way limit the scope of the appended claims to such detail. It is, of course, not possible to describe every conceivable combination of components or methodologies for purposes of describing the various aspects of the subject matter. Therefore, the disclosure is not limited to the specific details or the illustrative examples shown and described.

To the extent that the term “includes” or “including” is employed in the detailed description or the claims, it is intended to be inclusive in a manner similar to the term “comprising” as that term is interpreted when employed as a transitional word in a claim.

1-25. (canceled)

26. A computer-implemented method comprising:
electronically generating, via a graphical user interface (GUI) rendered on a display of a computing device, a digital representation of one or more categories of content, at least one category of content thereof comprising a particular on-screen layout digitally rendered via a plurality of GUI elements based, at least in part, on the one or more categories of content, the plurality of GUI elements comprising one or more of the following:
an origin element designating a rotation point for an on-screen rotation of at least a portion of the particular on-screen layout about the origin element;
a common region comprising one or more concentrically-aligned annular regions extending radially from the origin element;
one or more digital fields comprising one or more unique identifier values geometrically arranged about a periphery of the one or more concentrically-aligned annular regions;
one or more digitally rendered lines extending outwardly from the origin element towards the one or more digital fields, the one or more digitally rendered lines having one or more variable aspects designating properties of the one or more unique identifier values;
one or more electronically captured activity symbols digitally arranged outside an outermost concentrically-aligned annular region of the one or more concentrically-aligned annular regions, the one or more electronically captured activity symbols designating respective computed action states associated with corresponding unique identifier values of the one or more unique identifier values;
or any combination thereof;
continually processing one or more digital data streams with respect to the one or more categories of content, a particular digital data stream of the one or more digital data streams corresponding to a different source;
computing, using a combination of the one or more digital data streams, one or more positional relationships for at least a subset of the plurality of GUI elements based, at least in part, on the continually processing of the one or more digital data streams; and
dynamically positioning the at least a subset of the plurality of GUI elements on the display as part of the particular on-screen layout based, at least in part, the one or more computed positional relationships.

27. The method of claim 26, wherein the one or more digital data streams comprise one or more of the following: real-time or near real-time updates; historical data records; or any combination thereof; and wherein dynamically positioning the at least a subset of the plurality of GUI elements is being performed in real-time or near real-time based, at least in part, on the one or more real-time or near real-time updates.

28. The method of claim 26, wherein the one or more variable aspects of the one or more digitally rendered lines are representative of event-related information for the one or more unique identifier values, the event-related information comprising one or more of the following: one or more past events; one or more current events; one or more future events; or any combination thereof, based, at least in part, on the one or more digital data streams.

29. The method of claim 26, wherein the one or more digitally rendered lines include one or more visual attributes comprising one or more of the following: one or more colors, one or more sizes, one or more shapes, or any combination thereof, and wherein the one or more digitally rendered lines comprise one or more of the following: one or more line types comprising one or more of broken lines, one or more solid lines, one or more weighted lines, or any combination thereof.

30. The method of claim 26, wherein the one or more unique identifier values are associated with one or more digitally rendered markers positioned on the display within the one or more concentrically-aligned annular regions and representing one or more of the following: a threshold-based condition; an upcoming event; a recent event; a forecasted event; or any combination thereof.

31. The method of claim 30, wherein the one or more digital markers positioned within the one or more concentrically-aligned annular regions comprise at least two marker types representing different categories of event-related information associated with the one or more unique identifier values, the event-related information comprising one or more of the following: insider transaction activity, one or more pattern-based events identified over a time window, one or more scheduled distribution events, one or more proximity conditions between a value and a reference value, or any combination thereof.

32. The method of claim 26, wherein the one or more digital data streams comprise, for at least a subset of the one or more unique identifier values, digitally captured data representing one or more of the following: one or more historical values, one or more real-time values, transaction volume, one or more scheduled distributions, or any combination thereof.

33. The method of claim 26, wherein the one or more digitally rendered lines include a digitally rendered line regarding dividend-related information for at least a subset of the one or more unique identifier values, the digitally rendered line having one or more visual attributes representing whether a corresponding unique identifier value is associated with one or more of the following: a dividend-related event; an amount of dividend-related events within a pre-defined interval; a frequency of dividend-related events within a pre-defined interval; or any combination thereof.

34. The method of claim 26, wherein dynamically positioning the at least the subset of the plurality of GUI elements comprises extending a dividend-related line from the origin element in a radial direction toward a corresponding unique identifier value such that at least a portion of the dividend-related line overlays at least one digital marker positioned within the one or more concentrically-aligned annular regions along the radial direction, the overlay representing a temporal overlap between a dividend-related event associated with the dividend-related line and an event represented by the at least one digital marker.

35. The method of claim 26, wherein the one or more electronically captured activity symbols comprise a ticker symbol associated with a corresponding unique identifier value, and wherein the one or more electronically captured activity symbols are displayed with a visual rendering applied to at least a portion of the ticker symbol representing a computed action state comprising one or more of the following: a buy; a sell; a hold; or any combination thereof, based, at least in part, on the one or more digital data streams.

36. The method of claim 35, wherein the visual rendering comprises one or more of the following: a color, font weight, underline, border, iconography, animation, a positional offset applied to at least a portion of the ticker symbol, based, at least in part, on the computed action state and the one or more digital data streams.

37. The method of claim 26, wherein the one or more digital data streams comprise insider transaction data, and wherein continually processing the insider transaction data comprises receiving, for a corresponding insider transaction, one or more of the following: an insider name, an insider title; a transaction date; a transaction volume; a transaction type; or any combination thereof, the transaction type comprising one or more of the following: a purchase, a sale, an option exercise, an equity grant receipt; or any combination thereof.

38. The method of claim 26, wherein the one or more categories of content comprises one or more of the following: a financial asset category comprising one or more tradeable assets; a sports category comprising one or more athletes, teams, or sporting events; a media category comprising one or more digital content items, creators, or engagement metrics; a real estate category comprising one or more properties or real estate investment instruments; a cryptocurrency category comprising one or more digital currency assets or blockchain-based instruments; a watchlist category comprising one or more user-curated content items; or any combination thereof; or any combination thereof.

39. The method of claim 26, wherein the particular on-screen layout comprises a dynamic wheel-type digital interface.

40. The method of claim 26, wherein dynamically positioning the at least a subset of the plurality of GUI elements on the display as part of the particular on-screen layout is further based, at least in part, on updating the particular on-screen layout in response to changes in the one or more digital data streams.

41. The method of claim 26, wherein the computed action states indicate recommended actions, the computed action states comprising one or more of the following: typeface formatting; one or more recommendation symbols; or any combination therefore.

42. An apparatus, comprising:
a processor coupled to a memory of at least one computing device, the processor to:
electronically generate, via a graphical user interface (GUI) rendered on a display of the at least one computing device, a digital representation of one or more categories of content, at least one category of content thereof comprising a particular on-screen layout digitally rendered via a plurality of GUI elements based, at least in part, on the one or more categories of content, the plurality of GUI elements comprising one or more of the following:
an origin element designating a rotation point for an on-screen rotation of at least a portion of the particular on-screen layout about the origin element;
a common region comprising one or more concentrically-aligned annular regions extending radially from the origin element;
one or more digital fields comprising one or more unique identifier values geometrically arranged about a periphery of the one or more concentrically-aligned annular regions;
one or more digitally rendered lines extending outwardly from the origin element towards the one or more digital fields, the one or more digitally rendered lines having one or more variable aspects designating properties of the one or more unique identifier values;
one or more electronically captured activity symbols digitally arranged outside an outermost concentrically-aligned annular region of the one or more concentrically-aligned annular regions, the one or more electronically captured activity symbols designating respective computed action states associated with corresponding unique identifier values of the one or more unique identifier values;
or any combination thereof;
continually process one or more digital data streams with respect to the one or more categories of content, a particular digital data stream of the one or more digital data streams corresponding to a different source;
compute, using a combination of the one or more digital data streams, one or more positional relationships for at least a subset of the plurality of GUI elements based, at least in part, on the continually processing of the one or more digital data streams; and
dynamically position the at least a subset of the plurality of GUI elements on the display as part of the particular on-screen layout based, at least in part, on the one or more computed positional relationships.

43. The apparatus of claim 42, wherein the one or more digital data streams comprise one or more of the following: real-time or near real-time updates; historical data records; or any combination thereof; and wherein dynamically positioning the at least a subset of the plurality of GUI elements is being performed in real-time or near real-time based, at least in part, on the one or more real-time or near real-time updates.

44. The apparatus of claim 42, wherein the one or more variable aspects of the one or more digitally rendered lines are representative of event-related information for the one or more unique identifier values, the event-related information comprising one or more of the following: one or more past events; one or more current events; one or more future events; or any combination thereof, based, at least in part, on the one or more digital data streams.

45. An article, comprising:
a computer-readable medium having stored thereon instructions executable by a computing device to:
electronically generate, via a graphical user interface (GUI) rendered on a display of the computing device, a digital representation of one or more categories of content, at least one category of content thereof comprising a particular on-screen layout digitally rendered via a plurality of GUI elements based, at least in part, on the one or more categories of content, the plurality of GUI elements comprising one or more of the following:
an origin element designating a rotation point for an on-screen rotation of at least a portion of the particular on-screen layout about the origin element;
a common region comprising one or more concentrically-aligned annular regions extending radially from the origin element;
one or more digital fields comprising one or more unique identifier values geometrically arranged about a periphery of the one or more concentrically-aligned annular regions;
one or more digitally rendered lines extending outwardly from the origin element towards the one or more digital fields, the one or more digitally rendered lines having one or more variable aspects designating properties of the one or more unique identifier values;
one or more electronically captured activity symbols digitally arranged outside an outermost concentrically-aligned annular region of the one or more concentrically-aligned annular regions, the one or more electronically captured activity symbols designating respective computed action states associated with corresponding unique identifier values of the one or more unique identifier values;
or any combination thereof;
continually process one or more digital data streams with respect to the one or more categories of content, a particular digital data stream of the one or more digital data streams corresponding to a different source;
compute, using a combination of the one or more digital data streams, one or more positional relationships for at least a subset of the plurality of GUI elements based, at least in part, on the continually processing of the one or more digital data streams; and
dynamically position the at least a subset of the plurality of GUI elements on the display as part of the particular on-screen layout based, at least in part, on the one or more computed positional relationships.

46. The article of claim 45, wherein the one or more digital data streams comprise one or more of the following: real-time or near real-time updates; historical data records; or any combination thereof; and wherein dynamically positioning the at least a subset of the plurality of GUI elements is being performed in real-time or near real-time based, at least in part, on the one or more real-time or near real-time updates.
